(19) United States
(12) Patent Application Publication
(10) Pub. No.: US 2025/0338791 A1
(43) Pub. Date: Nov. 6, 2025

(54) METERING ASSEMBLY, SYSTEM AND METHOD FOR DISTRIBUTING AGRICULTURAL PRODUCT

(71) Applicant: Bourgault Industries Ltd., St. Brieux (CA)

(72) Inventors: Scot Jagow, St. Brieux (CA); Scott Gerbrandt, St. Brieux (CA)

(21) Appl. No.: 19/271,160

(22) Filed: Jul. 16, 2025

Related U.S. Application Data
(63) Continuation of application No. PCT/CA2024/050220, filed on Feb. 23, 2024.
(60) Provisional application No. 63/448,048, filed on Feb. 24, 2023.

(51) Int. Cl. A01C 15/00

(52) U.S. Cl. CPC A01C 15/007

(57) ABSTRACT

A metering assembly for distribution of agricultural product includes a transfer chamber having an open upper end for receiving product into a chamber interior, and a chamber width extending along a lateral axis. The metering assembly further includes a plurality of metering devices coupled to the transfer chamber. Each metering device has a rotary propelling member with a protruding portion that protrudes into the chamber interior and a meter outlet external the chamber. The metering devices are arranged in pairs, each pair including a first metering device of the plurality of metering devices and a second metering device of the plurality of metering devices. The protruding portions of the first and second metering devices of each pair are spaced apart from one another on opposite sides of the lateral axis.

### CROSS-REFERENCES TO RELATED APPLICATIONS

This application is a continuation of International Application No. PCT/CA2024/050220, filed Feb. 23, 2024, which claims priority from U.S. Provisional Patent Application No. 63/448,048, filed on Feb. 24, 2023, the entire contents of which are hereby incorporated by reference for all purposes.

### FIELD

The teaching disclosed herein relates to apparatuses and methods for delivering agricultural product, such as, seed, fertilizer, etc. from a tank to an agricultural implement for application to a field.

### INTRODUCTION

U.S. Pat. No. 9,585,305 (Henry) discloses a particulate material delivery system that allows for variable rate sectional control while delivering particulate material to an agricultural field. The system may include an air cart and a drill that are towable behind a tractor and that includes a metering system receiving product from the air cart and delivering the product to the drill for distribution to the ground, such as an agricultural field. The metering system includes multiple metering units that receive separate portions of the product from the air cart. Multiple prime movers drive the multiple metering units. A controller is connected to and individually controls the multiple prime movers such that distribution rates of the multiple metering units can be varied independently of each other.

U.S. Pat. No. 10,080,324 (Sheppard) discloses a mobile air cart including a metering assembly configured to receive particulate from a tank and to deliver particulate to pneumatic conveying lines. The metering assembly includes a wall structure that defines a unitary, common metering chamber. The metering assembly further includes a plurality of meter units. The meter units are configured to meter and separate particulate within the chamber into respective particulate flows corresponding to the conveying lines.

Canadian Patent No. 2,984,836 (Beaujot) discloses a metering assembly for use with an air seeding apparatus. The metering assembly comprises: a plurality of independently controllable rotatable flow controllers, wherein each rotatable flow controller is configured to rotate about a rotational axis; a plurality of metering devices, each metering device having a housing and configured to receive agricultural product from a storage tank, wherein each rotatable flow controller is disposed within a respective housing such that each rotational axis of each rotatable flow controller are generally parallel to one another and not aligned with one another, and each rotatable flow controller is configured to meter the agricultural product from the storage tank; and a plurality of distribution lines, wherein each distribution line is disposed downstream from a respective rotatable flow controller and configured to receive the agricultural product output from the respective rotatable flow controller.

### SUMMARY

The following summary is intended to introduce the reader to various aspects of the applicant's teaching, but not to define any invention.

In one aspect, a distribution system for agricultural product is disclosed. The distribution system includes a mobile tank for holding a supply of product. The tank includes a transfer chamber adjacent a lower end of the tank. The transfer chamber is at least partially enclosed by a chamber outer wall and the transfer chamber has a chamber width extending along a lateral axis. The distribution system further includes a plurality of first chamber apertures in the chamber outer wall. The first chamber apertures are spaced laterally apart from one another along the chamber width on a first side of the lateral axis. The distribution system further includes a plurality of second chamber apertures in the chamber outer wall. The second chamber apertures are spaced laterally apart from one another along the chamber width on a second side of the lateral axis opposite the first side. The distribution system further includes a plurality of first metering devices. Each first metering device is proximate a respective first chamber aperture and has a first outlet and a first propelling member upstream of the first outlet for urging conveyance of metered product from the transfer chamber of the tank through the respective first chamber aperture to the first outlet. The distribution system further includes a plurality of second metering devices. Each second metering device is proximate a respective second chamber aperture and has a second outlet and a second propelling member upstream of the second outlet for urging conveyance of metered product from the transfer chamber of the tank through the respective second chamber aperture to the second outlet. The distribution system further includes a plurality of distribution lines downstream of the first and second outlets for delivery of the metered product from the plurality of first and second metering devices to an agricultural implement for application to a field.

In some examples, the second chamber apertures are located at positions along the lateral axis that are generally equal to positions along the lateral axis at which the first chamber apertures are located.

In some examples, each first propelling member includes a first rotary body with a first fluted outer surface for engaging the product, each second propelling member includes a second rotary body with a second fluted outer surface for engaging the product, and rotation of any one of the first and second rotary bodies is controllable independently of any other one of the first and second rotary bodies.

In some examples, each first propelling member includes a first auger extending along a first meter axis and a first drive for urging rotation of the first auger, each second propelling member includes a second auger extending along a second meter axis and a second drive for urging rotation of the second auger, and rotation of the first and second augers transfers the metered product from the transfer chamber to one or more of the plurality of distribution lines.

In some examples, the first auger of each first metering device is rotatable within a first casing disposed external the transfer chamber and extending between the chamber outer wall and the first outlet, and the second auger of each second metering device is rotatable within a second casing extending between the chamber outer wall and the second outlet.

In some examples, the lateral axis of the transfer chamber is oriented in a horizontal plane when the mobile tank is on level ground, and each first meter axis is inclined relative to the horizontal plane by a first meter angle and each second meter axis is inclined relative to the horizontal plane by a second meter angle.

In some examples, the first outlets of each first metering device are at an elevation greater than the first chamber apertures, and the second outlets of each second metering device are at an elevation greater than the second chamber apertures.

In some examples, each of the first meter angle and the second meter angle is in a range from about 20 degrees to about 60 degrees.

In some examples, the transfer chamber is mounted below a discharge opening in a floor of the tank.

In some examples, the transfer chamber includes a divider that divides an interior of the transfer chamber into a first chamber portion in communication with the first metering devices and a second chamber portion in communication with the second metering devices.

In some examples, the divider includes a first inclined panel having a first upper edge extending along the lateral axis of the transfer chamber and a first lower edge spaced below the lateral axis and horizontally away from the lateral axis towards the first chamber apertures. The divider further includes a second inclined panel having a second upper edge proximate the first upper edge and a second lower edge spaced below the lateral axis and horizontally away from the lateral axis towards the second chamber apertures.

In some examples, the chamber outer wall includes a first sidewall oriented generally parallel to a lower portion of the first inclined panel and spaced therefrom in a direction parallel to the first meter axes. The chamber outer wall further includes a second sidewall oriented generally parallel to a lower portion of the second inclined panel and spaced therefrom in a direction parallel to the second meter axes.

In some examples, the chamber outer wall further includes a first bottom panel extending between the first lower edge of the first inclined panel and a first bottom edge of the first sidewall. The chamber outer wall further includes a second bottom panel extending between the second lower edge of the second inclined panel and a second bottom edge of the second sidewall.

In some examples, the first chamber apertures are provided in the first sidewall and the second chamber apertures are provided in the second sidewall.

In some examples, the distribution system includes three to six of the first metering devices and an equal quantity of the second metering devices in opposing relation to the first metering devices, and the chamber width is less than 100 cm.

In some examples, the distribution system includes five of the first metering devices and five of the second metering devices in opposing relation to the first metering devices, and the chamber width is less than 85 cm.

In some examples, the transfer chamber is at least partially enclosed by opposed first and second end walls, and the chamber width extends from one to the other of the first and second end walls.

In some examples, the distribution system further includes a lateral divider in the transfer chamber. The lateral divider has a divider width that extends generally along the lateral axis and separates the chamber interior into a first chamber portion in communication with the first metering devices and a second chamber portion in communication with the second metering devices.

In some examples, each first chamber aperture is in communication with at least one adjacent first chamber aperture through the first chamber portion of the transfer chamber, wherein product entering the first chamber portion proximate any one first metering device is extractable by the one first metering device and by at least another first metering device adjacent thereto.

In some examples, each second chamber aperture is in communication with at least one adjacent second chamber aperture through the second chamber portion of the transfer chamber, wherein product entering the second chamber portion proximate any one second metering device is extractable by the one second metering device and by at least another second metering device adjacent thereto.

In some examples, the lateral divider comprises a divider central portion having a generally circular shape when viewed from above, the divider central portion having a midpoint positioned along the lateral axis, and the transfer chamber extending about a periphery of the central divider, with the first chamber portion and the second chamber portions disposed on opposite sides of the lateral axis. The chamber outer wall of the transfer chamber surrounds the periphery of the divider central portion and is spaced radially apart therefrom by a radial gap. The lateral divider further comprises, in some examples, a lateral divider wall extending across the radial gap proximate the lateral axis at each side of the transfer chamber and along a height of the transfer chamber to further separate the first chamber portion from the second chamber portion.

In some examples, the distribution system further includes a plurality of first subdividers in the first chamber portion. Each first subdivider is disposed between a respective pair of adjacent first chamber apertures and extends upward from a bottom of the first chamber portion along at least a first portion of a height of the transfer chamber to provide a plurality of discrete first feed zones. Each first feed zone is in communication with a respective one of the first metering devices.

In some examples, the distribution system further includes a plurality of second subdividers in the second chamber portion. Each second subdivider is disposed between a respective pair of adjacent second chamber apertures and extends upward from a bottom of the second chamber portion along at least a second portion of the height of the transfer chamber to provide a plurality of discrete second feed zones. Each second feed zone is in communication with a respective one of the second metering devices.

In some examples, the transfer chamber includes an undulating bottom surface including contoured portions beneath a lower portion of each first and second propelling member and raised portions between adjacent contoured portions to help reduce product stagnation between adjacent metering devices.

In some examples, the plurality of distribution lines includes an upper layer of upper distribution lines equal in quantity to a combined total of the plurality of first metering devices and the plurality of second metering devices. The upper distribution lines are arranged side-by-side at a common elevation beneath the transfer chamber. A horizontal spacing between sequentially adjacent upper distribution lines alternates between (i) a broad spacing to accommodate a first transfer conduit and a second transfer conduit therebetween, the first and second transfer conduits extending from the first and second outlets, respectively, of a pair of opposed ones of the first and second metering devices for supplying metered product to respective lower distribution lines disposed below the upper distribution lines, and (ii) a narrow spacing to facilitate reducing the chamber width.

In another aspect, a method for distributing agricultural product is disclosed. The method includes staging product in a transfer chamber adjacent a lower end of a mobile tank. The transfer chamber is at least partially enclosed by a chamber outer wall and has a chamber width extending along a lateral axis. The method further includes withdrawing staged product from the transfer chamber through a plurality of metering devices including a set of first metering devices proximate a corresponding set of first chamber apertures in the chamber outer wall arranged side-by side along a first side of the lateral axis, and a set of second metering devices proximate a corresponding set of second chamber apertures in the chamber outer wall arranged side-by side along a second side of the lateral axis opposite the first side. The method further includes directing metered product from an outlet of each metering device to a respective distribution line for delivery to an agricultural implement for application to a field.

In another aspect, a metering assembly for distribution of agricultural product is disclosed. The metering assembly includes a transfer chamber having an open upper end for receiving product into a chamber interior, and a chamber width extending along a lateral axis. The metering assembly further includes a plurality of metering devices coupled to the transfer chamber. Each metering device has a rotary propelling member with a fluted outer surface and a protruding portion that protrudes into the chamber interior. Each metering device also has a meter outlet external the transfer chamber. The protruding portions of respective first metering devices of the plurality of metering devices are arranged on a first side of the lateral axis, and the protruding portions of respective second metering devices of the plurality of metering devices are arranged on a second side of the lateral axis opposite the first side.

In some examples, the protruding portions of the first metering devices are spaced equally from the lateral axis by a first horizontal distance, and the protruding portions of the second metering devices are spaced equally from the lateral axis by a second horizontal distance.

In some examples, the protruding portions of the first metering devices are spaced apart along a first arc when viewed from above. The first arc has a first arc central portion disposed between first arc end positions. The first arc central portion is spaced further from the lateral axis than the first arc end portions.

In some examples, the protruding portions of the second metering devices are spaced apart along a second arc when viewed from above. The second arc is arranged opposite the first arc and has a second arc central portion disposed between second arc end positions. The second arc central portion is spaced further from the lateral axis than the second arc end portions.

In some examples, the protruding portions and the meter outlets are at a common elevation.

In some examples, the protruding portions are at a common upstream elevation and the meter outlets are at a common downstream elevation. The downstream elevation is greater than the upstream elevation.

In some examples, each rotary propelling member includes a metering wheel having a hub and a plurality of vanes extending radially outwardly from the hub.

In some examples, each rotary propelling member includes an auger having at least one helical flight extending along a shaft.

Other aspects and features of the teachings disclosed herein will become apparent to those ordinarily skilled in the art, upon review of the following description of the specific examples of the present disclosure.

### DRAWINGS

For a better understanding of the described examples and to show more clearly how they may be carried into effect, reference will now be made, by way of example, to the accompanying drawings in which:

FIG. 1 is a schematic illustration of a distribution system for agricultural product according to aspects of the teaching disclosed herein;

FIG. 2 is an enlarged view of a portion of the distribution system identified at box 2 of FIG. 1;

FIG. 3 is a cross-sectional view of a portion of the distribution system of FIG. 1, taken along the line 3-3;

FIG. 3a is an exploded rear perspective view of a portion of the system of FIG. 1;

FIG. 4 is an upper front perspective view of a metering assembly portion of the system of FIG. 1;

FIG. 5 is a top view of the metering assembly of FIG. 4;

FIG. 6 is a cross-sectional view of the metering assembly of FIG. 5 taken along line 6-6;

FIG. 7 is a front perspective view of a transfer chamber portion of the metering assembly of FIG. 4;

FIG. 8 is an enlarged view of structure shown at box 8 of FIG. 3;

FIG. 9 is a perspective view of another metering assembly for distributing agricultural product according to aspects of the teaching disclosed herein;

FIG. 10 is a top view of the metering assembly of FIG. 9;

FIG. 11 is a cross-sectional view of the metering assembly of FIG. 10 taken along line 11-11;

FIG. 12 is a side view of the metering assembly of FIG. 9;

FIG. 13 is a cross-sectional view of the metering assembly of FIG. 12 taken along staggered line 13-13;

FIG. 14 is a top view of another metering assembly for distributing agricultural product according to aspects of the teaching disclosed herein;

FIG. 14a is a cross-sectional view of the metering assembly of FIG. 14 taken along line 14a-14a;

FIG. 15 is a perspective view of another metering assembly for distributing agricultural product according to aspects of the teaching disclosed herein;

FIG. 16 is a top view of the metering assembly of FIG. 15;

FIG. 16a is a cross-sectional view of the metering assembly of FIG. 16 taken along line 16a-16a;

FIG. 17 is a perspective view of another metering assembly for distributing agricultural product according to aspects of the teaching disclosed herein;

FIG. 18 is a top view of the metering assembly of FIG. 17;

FIG. 19 is a cross-sectional view of the metering assembly of FIG. 18 taken along line 19-19;

FIG. 20 is a perspective view of another metering assembly for distributing agricultural product according to aspects of the teaching disclosed herein;

FIG. 21 is a top view of the metering assembly of FIG. 20; and

FIG. 22 is a cross-sectional view of the metering assembly of FIG. 21 taken along line 22-22.

The drawings included herewith are for illustrating various examples of apparatuses and methods of the teaching of the present specification and are not intended to limit the scope of what is taught in any way.

### DESCRIPTION OF VARIOUS EXAMPLES

Various apparatuses or processes will be described below to provide an example of each claimed invention. No example described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an example of any claimed invention. Any invention disclosed in an apparatus or process described below that is not claimed in this document may be the subject matter of another protective instrument, for example, a continuing patent application, and the applicants, inventors, or owners do not intend to abandon, disclaim, or dedicate to the public any such invention by its disclosure in this document.

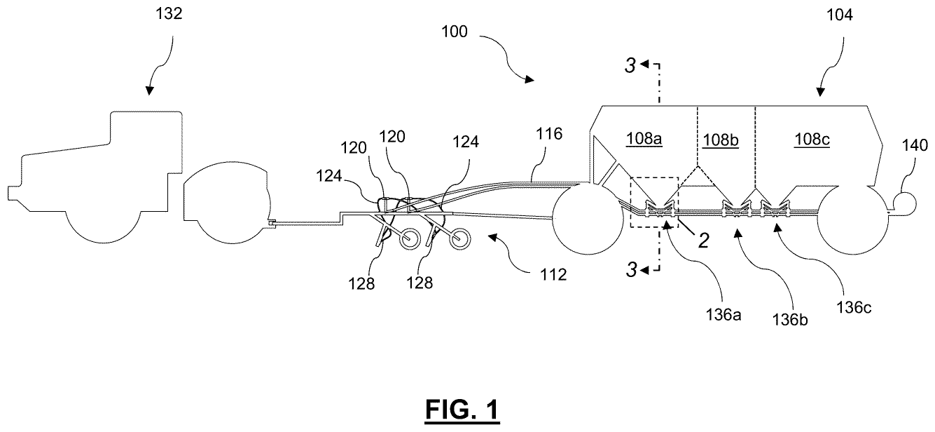

Referring to FIG. 1, a distribution system 100 for applying agricultural product to a field includes an air cart 104. The air cart 104 includes one or more mobile tanks 108, each tank 108 for holding a supply of agricultural product (e.g., seed, fertilizer, etc.). The distribution system 100 further includes a plurality of metering devices to convey the agricultural product from the tanks 108 to an agricultural implement 112 through distribution lines 116 extending from the air cart 104. In the example illustrated, the distribution lines 116 have downstream ends connected to distribution manifolds 120 mounted on the agricultural implement 112. Secondary lines 124 extend from the distribution manifolds 120 to delivery boots 128 arranged on the agricultural implement 112 for depositing the agricultural product on the field. In operation, the air cart 104 and the agricultural implement 112 are towed by a tractor 132.

In the example illustrated, the air cart 104 includes three mobile tanks 108a, 108b, and 108c, each tank holding a supply of agricultural product. The same product or different products can be held in the tanks 108a, 108b, and 108c. In the example illustrated, each tank holds a distinct product, with tank 108a holding a supply of seed, tank 108b holding a supply of starter fertilizer, and tank 108c holding a supply of mid-band fertilizer.

The distribution system 100 further includes one or more metering assemblies 136, each for conveying agricultural product from a respective one of the mobile tanks 108 to the agricultural implement 112 through distribution lines 116. In the example illustrated, the distribution system 100 includes three metering assemblies 136a, 136b and 136c. Each metering assembly 136a, 136b and 136c is in communication with a lower end of a respective one of the tanks 108a, 108b, and 108c. In operation, each metering assembly 136 controls a rate of transfer of the agricultural product from the respective mobile tank 108 to the distribution lines 116.

The distribution lines 116 are supplied with an air flow for urging conveyance of the metered product received therein to the agricultural implement 112. In the example illustrated, the source of the supplied air flow is a fan 140 mounted on the air cart 104 and fluidly coupled to upstream ends of each distribution line 116.

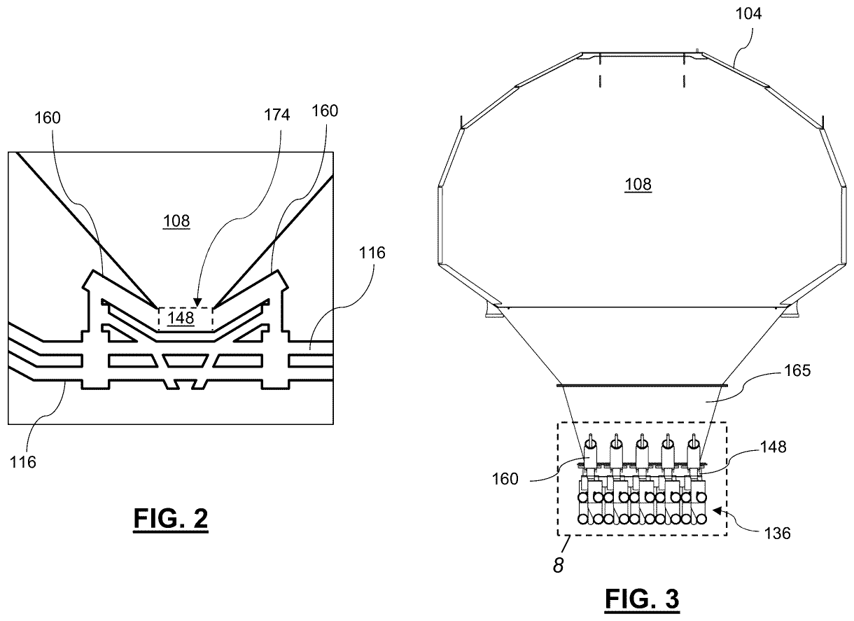

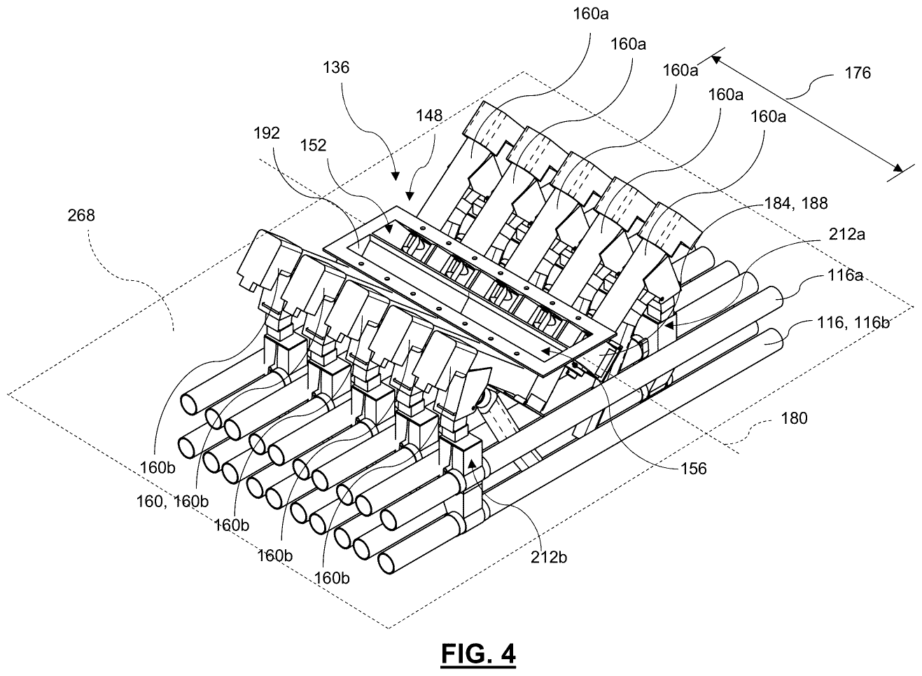

Referring to FIG. 2, the tank 108 includes a transfer chamber 148 adjacent a lower end of the tank 108, for staging product to be engaged by a plurality of metering devices 160. In the example illustrated, the transfer chamber 148 is separately secured to a lower end of the tank 108, and is mounted below a discharge opening 174 of the tank 108. The transfer chamber 148 has an open upper end 152 for receiving agricultural product into a chamber interior 156 (FIG. 4). In some examples, the transfer chamber, adjacent a lower end of the tank, is disposed within the tank, and can, for example, be defined by a lower portion of the tank interior.

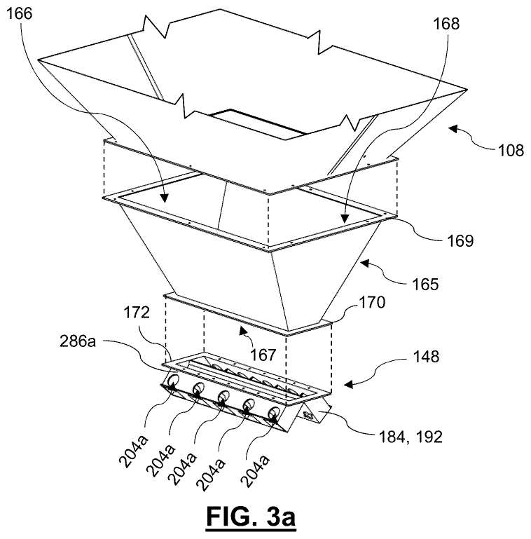

Referring to FIGS. 3 and 3a, the transfer chamber 148 is, in the example illustrated, secured to the lower end of the tank 108 via an optional adapter 165. The adapter 165 has an open upper end 166, an open lower end 167, and a product passage 168 extending between the open upper and lower ends 166, 167 for transferring agricultural product from the tank 108 to the transfer chamber 148. In the example illustrated, the adapter 165 includes an upper connection interface 169 (which can include, for example, a flange) extending about the perimeter of the open upper end 166 for securing the adapter 165 to the lower end of the tank 108. The adapter 165, in the example illustrated, also includes a lower connection interface 170 extending about the perimeter of the open lower end 167 for securing the adapter 165 to the transfer chamber 148.

In the example illustrated, the lower end of the tank 108 includes a tank connection interface 171. The upper connection interface 169 of the adapter 165 is of a complimentary size and shape to the tank connection interface 171 for securing the adapter 165 to the tank 108. Similarly, in the example illustrated, the transfer chamber 148 includes a transfer chamber connection interface 172 sized to secure to the lower connection interface 170 of the adapter 165. Mechanical fasteners, such as, e.g., screws, bolts, clamps, etc., can be used to secure the tank connection interface 171 to the upper connection interface 169 of the adapter 165 and the transfer chamber connection interface 172 to the lower connection interface 170 of the adapter 165.

A variety of different tank adapters can be provided to facilitate securing a desired metering assembly (from a number of different metering assemblies) to a given tank. For example, two or more tank adapters can have identical upper connection interfaces 169, for attachment to the tank connection interface 171 of the tank 108. The two or more tank adapters can have distinct lower connection interfaces 170, for connection with different transfer chamber connection interfaces 172 of respective ones of two or more distinct transfer chambers (e.g., distinct transfer chambers 148, 1148, 2148, 3148, 4148, 5148 disclosed herein). From a user convenience and cost reduction standpoint, it may be preferable to manufacture one tank 108 having a standardized configuration and provide adapters 165 to allow that tank 108 to be secured to multiple differently configured transfer chambers 148, rather than providing multiple distinct tanks that each correspond to one specific configuration of transfer chamber).

Referring again to FIGS. 2 and 3, the plurality of metering devices 160 are arranged relative to the transfer chamber 148 to provide a small, more concentrated withdrawal area from which product is withdrawn from the transfer chamber 148 by the metering devices 160. This can facilitate reducing the size (e.g., width and/or length) of the transfer chamber 148 and/or reduce the cross-sectional area (in a horizontal plane) of the lower portion of the tank 108 above the transfer chamber 148 from which product is supplied to the transfer chamber 148. This in turn can provide advantages in use of the system, for example, by helping to reduce starvation of one or more metering devices 160 (e.g., by reducing the amount by which one ‘uphill’ metering device is elevated relative to a ‘downhill’ metering device when operating on sloped ground, since the distance between the two metering devices is reduced), and/or by helping to simplify cleanout of the tank 108 (e.g., when emptying the tank 108 of product, the metering devices 160 are able to remove all or almost all product from the tank 108; very little product is left behind for manual cleanout). In the example illustrated schematically in FIG. 2, the metering devices 160 are arranged along two sides of the transfer chamber 148, in opposed pairs. This can reduce a horizontal extent of the transfer chamber 148 compared to, for example, a configuration in which the metering devices are arranged along only one side of a tank and the number of distribution lines is unchanged.

Referring to FIG. 4, the plurality of distribution lines 116 includes, in the example illustrated, an upper layer of upper distribution lines 116a arranged side-by-side at a common elevation below the transfer chamber 148, and a lower layer of lower distribution lines 116b arranged side-by-side at an elevation below the upper layer of upper distribution lines 116a. In the example illustrated, the upper distribution lines 116a are equal in quantity to a combined total of the plurality of first metering devices 160a and the plurality of second metering devices 160b. Similarly, in the example illustrated, the lower distribution lines 116b are equal in quantity to a combined total of the plurality of first metering devices 160a and the plurality of second metering devices 160b. In the example illustrated, the two layers of distribution lines (upper distribution lines 116a and lower distribution lines 116b) facilitate configuring the distribution system as a “double shoot” system. In some examples, a third, intermediate layer of intermediate distribution lines is provided for configuring the system as a “triple shoot” system. In some examples, the system can be configured as a “single shoot” system, and the distribution lines 116 can be arranged in a single layer.

In the example illustrated, the system includes ten upper distribution lines 116a and ten lower distribution lines 116b. Furthermore, in the example illustrated, the system includes ten metering devices 160, optionally arranged in five pairs of opposed first and second metering devices 160a, 160b.

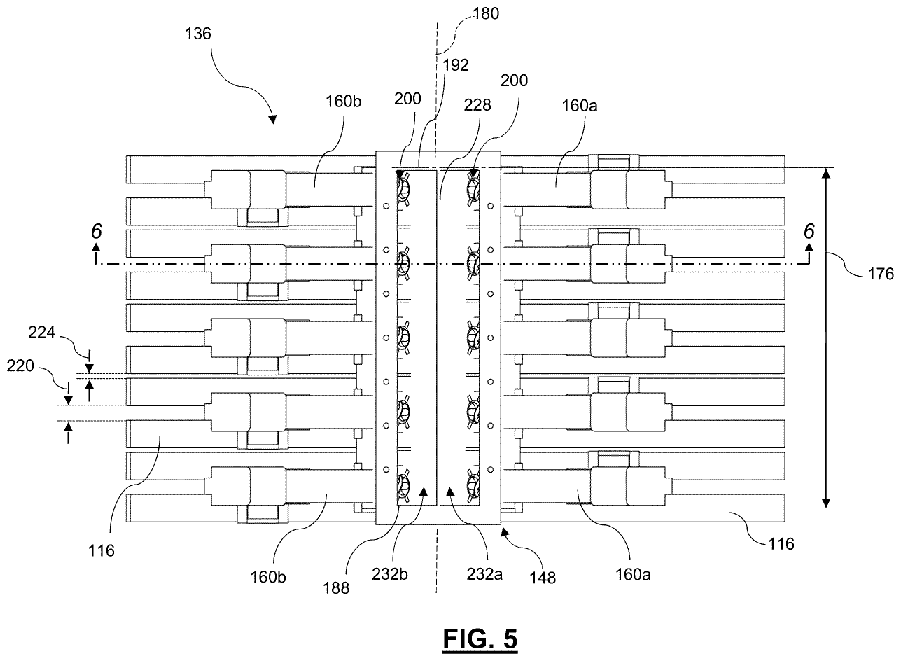

Referring to FIGS. 4 and 5, the transfer chamber 148 has a chamber width 176 extending along a lateral axis 180. In the example illustrated, the lateral axis 180 extends generally perpendicular to a direction of travel of the air cart 104 (FIG. 1). In other examples, the lateral axis 180 can be oriented differently, for example, generally parallel to the direction of travel. The transfer chamber 148 is at least partially enclosed by a chamber outer wall 184. In the example illustrated, the chamber outer wall 184 includes opposed first and second end walls 188, 192, and the chamber width 176 extends from one to the other of the first and second end walls 188, 192.

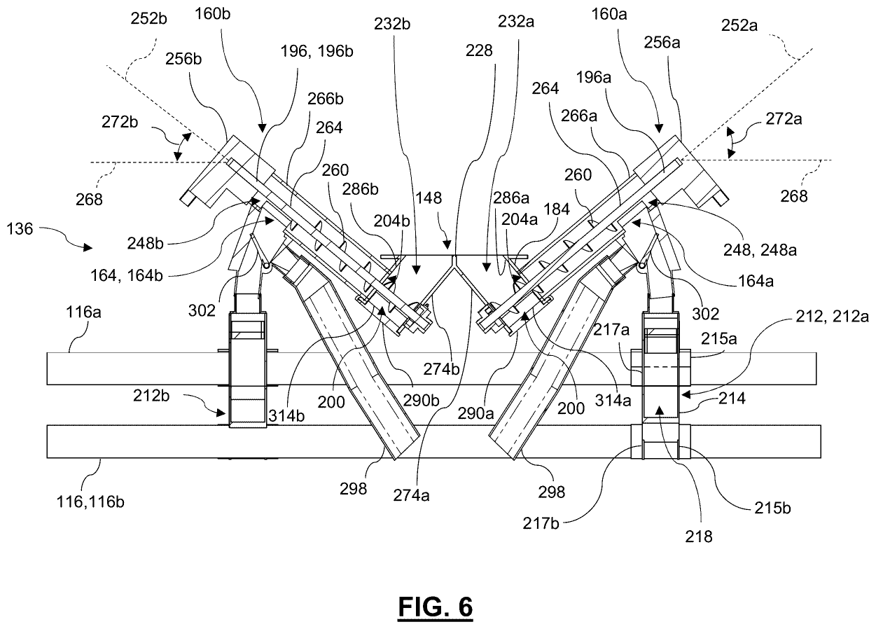

Staged product is withdrawn from the transfer chamber 148 by the plurality of metering devices 160. Referring to FIG. 6, each metering device 160 has a meter outlet 164 and a rotary propelling member 196 upstream of the meter outlet 164 for urging conveyance of metered product from the transfer chamber 148 to the meter outlet 164. The meter outlets 164 are external to the transfer chamber 148. In the example illustrated, the rotary propelling member 196 has a protruding portion 200 that protrudes into the chamber interior 156 (FIG. 5). The protruding portion 200 engages the product in the transfer chamber 148 and propels it downstream of the protruding portion 200 toward a respective distribution line 116.

Referring again to FIGS. 4 and 5, in the example illustrated, the metering devices 160 are optionally arranged in pairs. Each pair includes a first metering device 160a of the plurality of metering devices and a second metering device 160b of the plurality of metering devices. With reference to FIG. 6, each first metering device 160a has a first meter outlet 164a and a first rotary propelling member 196a upstream of the first meter outlet 164a. Similarly, each second metering device 160b has a second meter outlet 164b and a second rotary propelling member 196b upstream of the second meter outlet 164b.

Referring to FIG. 5, in the example illustrated, the protruding portions 200 of the first and second metering devices 160a, 160b of each pair are spaced apart from one another on opposite sides of the lateral axis 180. In the example illustrated, the pairs are arranged side-by-side along the chamber width 176.

With reference to FIGS. 5-7, the chamber outer wall 184 includes a plurality of first chamber apertures 204a and a plurality of second chamber apertures 204b. The first chamber apertures 204a are spaced laterally apart from one another along the chamber width 176 on a first side of the lateral axis 180 (FIG. 5). The second chamber apertures 204b are spaced laterally apart from one another along the chamber width 176 on a second side of the lateral axis 180 opposite the first side.

In the example illustrated, each first metering device 160a is proximate a respective first chamber aperture 204a and each second metering device 160b is proximate a respective second chamber aperture 204b. In operation, the first propelling member 196a of each first metering device 160a conveys agricultural product from the transfer chamber 148, through the respective first chamber aperture 204a, to the respective first meter outlet 164a. In operation, the second propelling member 196b of each second metering device 160b conveys agricultural product from the transfer chamber 148, through the respective second chamber aperture 204b, to the respective second meter outlet 164b.

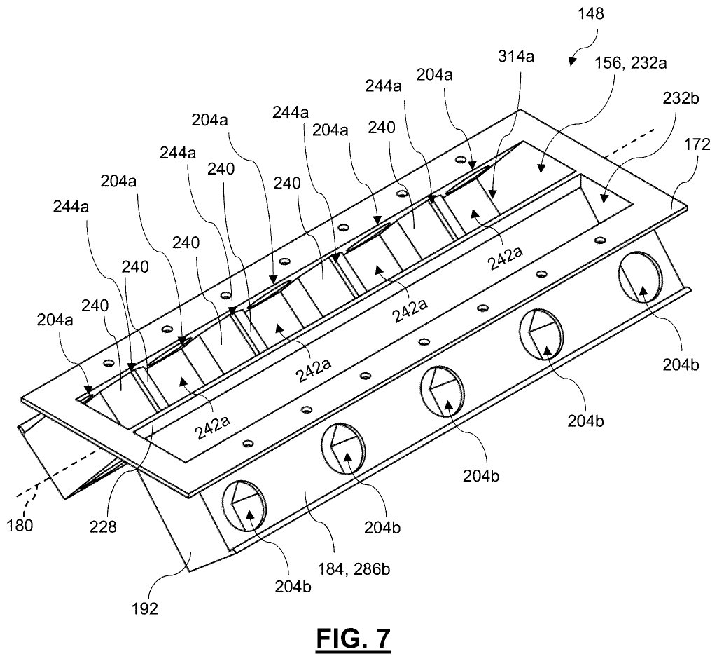

With reference to FIG. 7, the second chamber apertures 204b, in the example illustrated, are located at positions along the lateral axis 180 that are generally equal to positions along the lateral axis 180 at which the first chamber apertures 204a are located. Referring again to FIG. 5, in the example illustrated, the set of first metering devices 160a are arranged side-by-side along the first side of the lateral axis 180 and the set of second metering devices 160b are arranged side-by-side along the second side of the lateral axis 180 opposite the first side.

Referring to FIG. 6, the meter outlet 164 of each metering device 160 is coupled to a respective one of the upper distribution lines 116a and to a respective one of the lower distribution lines 116b, to selectively distribute metered product (from the meter outlet 164 to either one of the respective upper and lower distribution lines 116a, 116b). In the example illustrated, the respective upper and lower distribution lines 116a, 116b coupled to each meter outer 164 are arranged in vertically stacked pairs.

In the example illustrated, the system includes a plurality of transfer conduits 212, including a plurality of first transfer conduits 212a and a plurality of second transfer conduits 212b. Each transfer conduit 212 extends from a respective one of the meter outlets 164 to convey product from the meter outlet 164 to either one of the respective upper and lower distribution lines 116a, 116b (FIG. 6). In the example illustrated, each transfer conduit 212 includes a transfer manifold 214 with opposed first and second upper apertures 215a, 217a and opposed first and second lower apertures 215b, 217b. The first upper apertures 215a are aligned with, and coupled to, upstream ends of segments of respective upper distribution lines 116a positioned downstream of the transfer manifold, and the second upper apertures 217a are aligned with, and coupled to, downstream ends of segments of respective upper distribution lines 116a positioned upstream of the transfer manifold. Similarly, the first lower apertures 215b are aligned with, and coupled to, upstream ends of segments of respective lower distribution lines 116b positioned downstream of the transfer manifold, and the second lower apertures 217b are aligned with, and coupled to, downstream ends of segments of respective lower distribution lines 116b positioned upstream of the transfer manifold.

With reference to FIGS. 4 and 6, in the example illustrated, the first meter outlet 164a of each first metering device 160a is coupled to each of the upper and lower distribution lines 116a, 116b of a respective one of the stacked vertical pairs via a corresponding one of the first transfer conduits 212a. The second meter outlet 164b of each second metering device 160b is coupled to each of the upper and lower distribution lines 116a, 116b of a respective one of the stacked vertical pairs via a corresponding one of the second transfer conduits 212b.

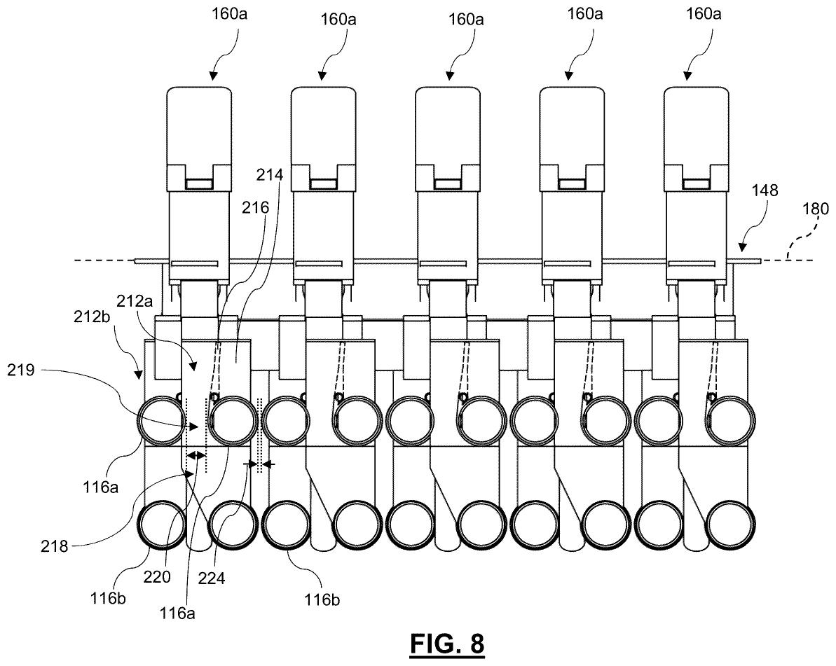

Referring to FIG. 8, each transfer conduit 212, in the example illustrated, includes a transfer channel 218 extending from an upper end of the transfer manifold 214 to the respective lower distribution line 116b. Each transfer channel 218 includes a passageway 219 inside the transfer manifold 214 and laterally beside the respective upper distribution line 116a. Furthermore, each transfer conduit 212a, 212b includes a diverter valve 216 (illustrated in broken lines) movable within the transfer channel 218 between a first position and a second position. Movement of the diverter valve 216 between the first and second positions selects which one of the upper and lower distribution lines 116a, 116b of the respective pair is in communication with the meter outlet 164 (FIG. 6). When the diverter valve 216 is in the first position, the meter outlet 164 of the respective metering device 160 is in communication with the upper distribution line 116a of the respective stacked pair (i.e., metered product discharged from the meter outlet 164 passes through the transfer channel 218 and into the upper distribution line 116a). When the diverter valve 216 is in the second position (as shown in FIG. 8), the meter outlet 164 of the respective metering device 160 is in communication with the lower distribution line 116b of the respective stacked pair (i.e., metered product discharged from the meter outlet 164 passes through passageway 219 of the transfer channel 218 and into the lower distribution line 116b).

In the example illustrated, a horizontal spacing between sequentially adjacent upper distribution lines 116a alternates between (i) a broad spacing 220 to accommodate first and second transfer conduits 212a, 212b therebetween, and (ii) a narrow spacing 224 to facilitate reducing the chamber width 176 (FIG. 5).

In some examples, the metering assembly 136 includes three to six of the first metering devices 160a and three to six of the second metering devices 160b in opposing relation to the first metering devices 160a. In some examples, the metering assembly 136 includes an equal quantity of first and second metering devices 160a, 160b (e.g., three first metering devices 160a and three second metering devices 160b). In some examples, the metering assembly 136 may include an unequal quantity of first and second metering devices 160a, 160b (e.g., five first metering devices 160a and four second metering devices 160b). In the example illustrated, the metering assembly 136 includes five of the first metering devices 160a and five of the second metering devices 160b in opposing relation to the first metering devices 160a.

In some examples, the chamber width 176 is less than 100 cm. In some examples, the chamber width 176 is less than 85 cm. A more compact chamber width 176 can help reduce stagnation areas within the chamber interior 156 (i.e., areas where the metering devices 160 are unable to access the agricultural product). A more compact chamber width 176 can also or alternatively reduce the risk of starving one or more of the metering devices 160 and/or simplify cleanout of the chamber interior 156 as there is less product left behind.

Referring again to FIG. 6, each metering device 160, in the example illustrated, includes a bypass conduit 298 downstream of the meter outlet 164 and upstream of the transfer conduit 212. In the example illustrated, any agricultural product conveyed through one of the bypass conduits 298 is expelled from the distribution system. The expelled product may be collected in a collection vessel (e.g., for re-use or disposal). The expelled product can be used for calibration purposes, by comparing the actual amount (e.g., weight) of product expelled by a meter over a set period of time to the expected amount of product expelled based on the length of the set time period and the speed of the meter. Alternatively or additionally, the bypass conduits 298 can be used to facilitate clean-out (emptying) of the mobile tank 108 of any remaining agricultural product after application of a desired amount of agricultural product to the field.

In the example illustrated, each bypass conduit 298 has an upstream end that includes a bypass valve 302 movable between a first position and a second position. When the bypass valve 302 is in the first position (as shown in FIG. 6), the meter outlet 164 of the respective metering device 160 is in communication with the bypass conduit 298. The bypass valve 302 blocks an upstream end of the transfer channel 218 when in the first position, thereby isolating the meter outlet 164 from the distribution lines 116. When the bypass valve 302 is in the second position, movement of the agricultural product from the meter outlet 164, through the transfer conduit 212, to the distribution lines 116 is unrestricted by the bypass valve 302. The meter outlet 164 of the respective metering device 160 remains in communication with transfer conduit 212 when the bypass valve 302 is in the second position.

In the example illustrated, the propelling members 196 include augers 248 (FIG. 6). Each auger 248 comprises a rotary body with a fluted outer surface in the form of a shaft 264 and at least one helical flight 260 extending along the shaft 264. Each first propelling member 196a includes a first auger 248a extending along a first meter axis 252a and a first drive, e.g., motor 256a, for urging rotation of the first auger 248a. Likewise, each second propelling member 196b includes a second auger 248b extending along a second meter axis 252b and a second drive, e.g., motor 256b, for urging rotation of the second auger 248b. Rotation of the first and second augers 248a, 248b conveys agricultural product staged in the transfer chamber 148 to the distribution lines 116.

In the example illustrated, the first auger 248a of each first metering device 160a is rotatable within a first tubular casing 266a extending between the chamber outer wall 184 and the first meter outlet 164a. Similarly, in the example illustrated, the second auger 248b of each second metering device 160b is rotatable within a second tubular casing 266b extending between the chamber outer wall 184 and the second meter outlet 164b. In the example illustrated, the first and second meter outlets 164a, 164b are defined by casing apertures in the sidewall of respective ones of the first and second tubular casings 266a, 266b, and each tubular casing includes, in the example illustrated, a downstream casing portion that extends at least partially between an upstream edge of the casing aperture and the respective motor 256a, 256b.

Referring still to FIG. 6, in the example illustrated, the first meter outlets 164a of each first metering device 160a are at an elevation greater than the first chamber apertures 204a. Likewise, the second meter outlets 164b of each second metering device 160b are at an elevation greater than the second chamber apertures 204b. In some examples, the first chamber apertures 204a and the first meter outlets 164a of each first metering device 160a are at a common elevation. In some examples, the second chamber apertures 204b and the second meter outlets 164b of each second metering device 160b are at a common elevation.

In the example illustrated, the protruding portions 200 of each metering device 160 are at a common upstream elevation and the meter outlets 164 are at a common downstream elevation that is greater than the upstream elevation. In some examples, the protruding portions 200 and the meter outlets 164 are at a common elevation.

With reference to FIGS. 4 and 6, the lateral axis 180 of the transfer chamber 148 is oriented in a horizontal plane 268 when the mobile tank 108 (FIG. 3) is on level ground. In the example illustrated, each first meter axis 252a is inclined relative to the horizontal plane 268 by a first meter angle 272a and each second meter axis 252b is inclined relative to the horizontal plane 268 by a second meter angle 272b. In some examples, each of the first meter angle 272a and the second meter angle 272b is in a range from about 20 degrees to about 60 degrees. In the example illustrated, each of the first meter angle 272a and the second meter angle 272b is 45 degrees. Such an arrangement can help save space as the inclined metering devices 160 will at least approximately follow the inclined outer surface of the lower end of the tank 108 (e.g., see FIG. 2).

Referring to FIGS. 5 and 6, the transfer chamber 148, in the example illustrated, includes a lateral divider 228 that divides the chamber interior 156 into a first chamber portion 232a, which is in communication with the first metering devices 160a, and a second chamber portion 232b, which is in communication with the second metering devices 160b. The divider 228, in the example illustrated, includes a first inclined panel 274a and a second inclined panel 274b. The first inclined panel 274a has an upper edge extending along the lateral axis 180 of the transfer chamber 148 and a lower edge spaced below the lateral axis 180 and horizontally away from the lateral axis 180 towards the first chamber apertures 204a. The second inclined panel 274b has an upper edge proximate the upper edge of the first inclined panel 274a and a lower edge spaced below the lateral axis 180 and horizontally away from the lateral axis 180 towards the second chamber apertures 204b.

The chamber outer wall 184, in the example illustrated, includes a first sidewall 286a and a second sidewall 286b. The first sidewall 286a is oriented generally parallel to a lower portion of the first inclined panel 274a and spaced therefrom in a direction parallel to the first meter axes 252a. The second sidewall 286b is oriented generally parallel to a lower portion of the second inclined panel 274b and spaced therefrom in a direction parallel to the second meter axes 252b. With reference to FIGS. 3a and 7, in the example illustrated, the first chamber apertures 204a are provided in the first sidewall 286a and the second chamber apertures 204b are provided in the second sidewall 286b.

Referring again to FIG. 6, the chamber outer wall 184, in the example illustrated, further includes a first bottom panel 290a and a second bottom panel 290b. The first bottom panel 290a extends between the lower edge of the first inclined panel 274a and a first bottom edge of the first sidewall 286a. The second bottom panel 290b extends between the lower edge of the second inclined panel 274b and a second bottom edge of the second sidewall 286b.

The transfer chamber 148 has a bottom surface that, in the example illustrated, includes a bottom surface first portion 314a (FIG. 6) at least partially bounding the first chamber portion 232a from below, and a bottom surface second portion 314b at least partially bounding the second chamber portion 232b from below. In the example illustrated, the bottom surface first and second portions 314a, 314b comprise inwardly directed surfaces of the first and second bottom panels 290a, 290b, respectively.

In the example illustrated, the bottom panels 290a, 290b, can be opened or removed to facilitate emptying the tank and metering system of product. For example, when changing over from one product to another product to be applied to the field, an operator can remove the bottom panels 290a, 290b to clean out any residual product from the transfer chamber left behind by the metering devices. This residual product can be collected in a suitable container. Reducing the amount of product to be handled in this manner can simplify this process, and in that regard, the bottom surface of the transfer chamber 148 can include optional contour features that can, for example, help to reduce product stagnation between adjacent metering devices and correspondingly, help reduce the amount of product left behind by the metering devices when emptying the tank. For example, the bottom surface can include alternating raised portions or peaks (positioned between adjacent protruding portions 200) and lowered portions or troughs (positioned beneath respective protruding portions 200), providing a generally undulating bottom surface. Product on either side of a given peak is directed toward respective adjacent troughs, where it can be extracted from the transfer chamber 148 by the protruding portion 200 of the metering device 160 aligned with the trough.

In the example illustrated, the bottom surface first portion 314a includes a plurality of first peaks 244a (FIG. 7) disposed between adjacent first chamber apertures 204a. The bottom surface first portion 314a further includes, in the example illustrated, a plurality of first troughs 242a disposed below, and in lateral alignment with, respective ones of the first chamber apertures 204a. In the example illustrated, each first peak 244a extends lengthwise between the first sidewall 286a and the first inclined panel 274a, along a peak axis that is oriented generally parallel to the first meter axes 252a. A sloped surface 240 extends from either side of each peak 244a, downwardly toward respective adjacent first troughs 242a. Similarly, the bottom surface second portion 314b optionally includes contour features to provide a generally undulating surface, including second peaks and second troughs arranged in mirror image to the corresponding features of the bottom surface first portion 314a.

In use, and with reference again to FIG. 6, product received by the transfer chamber 148 from the tank 108 is, in the example illustrated, divided into two portions, each portion respectively received by the first chamber portion 232a and the second chamber portion 232b. During normal operation, the first and second chamber portions 232a, 232b of the transfer chamber 148 are full of product (i.e., the spaces where the arrowheads of lines 232a and 232b are pointing in FIG. 6 are filled with product). All of the first metering devices 160a have access to the product in the first chamber portion 232a, and all of the second metering devices 160b have access to the product in the second chamber 232b. Product entering the first chamber portion 232a (for example), via the generally rectangular opening to the right of the divider 228 (FIG. 5), may ultimately be extracted by any one of the first metering devices 160a, or at least by either one of two adjacent first metering devices 160a. Similarly, product entering the second chamber portion 232b, via the generally rectangular opening to the left of the divider 228 (FIG. 5), may ultimately be extracted by any one of the second metering devices 160b, or at least by either one of two adjacent second metering devices 160b. Upon depletion, when the transfer chamber 148 is no longer receiving product from the tank, the peaks 244 can help direct residual product toward the troughs 242 beneath the protruding portions 200 of respective metering devices 160 for extraction by the metering devices. This can facilitate clean-out of the transfer chamber 148 (and ultimately the tank 108) by reducing the amount of product left behind in the transfer chamber 148 as unreachable (and therefore unextractable) by the metering devices 160.

Additionally or alternatively, in some examples, the first and second bottom panels 290a, 290b can be releasably secured to the transfer chamber 148 and/or otherwise movable between blocking and unblocking positions to help facilitate clean out of the transfer chamber 148 and the tank 108. In the example illustrated, the first and second bottom panels 290a, 290b are each movable between a blocking position (FIGS. 6, 7), in which the first and second chamber portions 232a are closed off from below by the first and second bottom panels 290a, 290b, respectively, to contain product in the first and second chamber portions 232a, 232b, and an unblocking position in which the first and second chamber portions 232a, 232b are at least partially unblocked from below to allow product to fall or drain from the first and second chamber portions 232a, 232b.

In some examples, moving the bottom panels 290a, 290b to the unblocking position provides a plurality of evacuation apertures at the bottom of the first and second chamber portions 232a, 232b, and the evacuation apertures can be in locations generally corresponding to where the troughs 242 are located when the bottom panels 290a, 290b are in the blocking positions. In some examples, each bypass conduit 298 has a sidewall opening in an upper sidewall surface, the sidewall opening aligned below a respective one of the evacuation apertures for receiving agricultural product that drains from the transfer chamber 148 when the respective bottom panel 290a, 290b is in the open position.

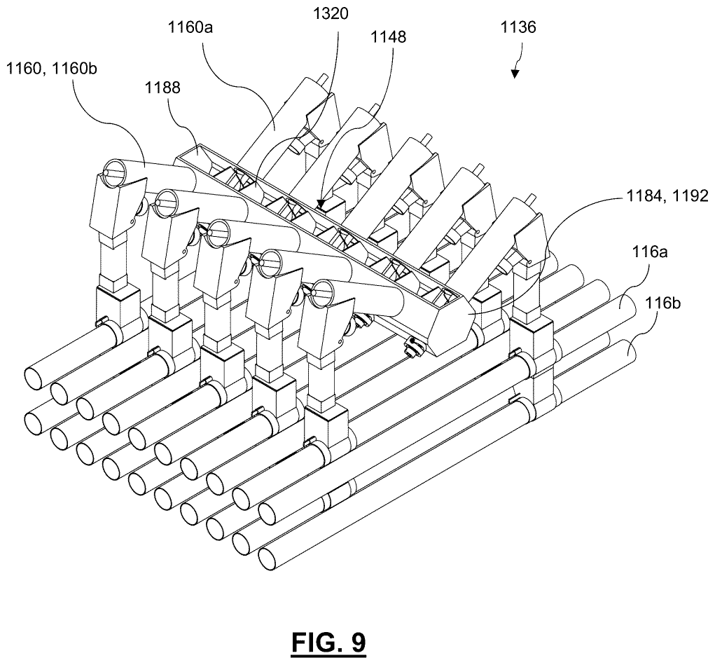

Referring to FIGS. 9-13, another example of a metering assembly 1136 in accordance with aspects of the present teaching has some similarity to the metering assembly 136, with like features identified by like reference characters, incremented by 1000.

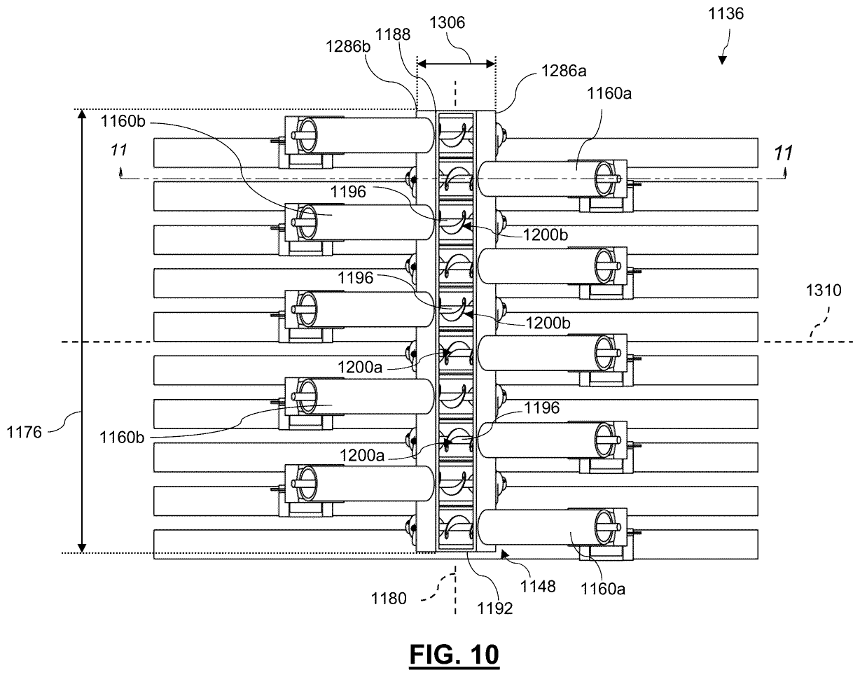

Referring to FIGS. 9 and 10, the metering assembly 1136 includes a transfer chamber 1148 and a plurality of metering devices 1160 coupled to the transfer chamber 1148. The transfer chamber 1148 has a chamber width 1176 extending along a lateral axis 1180 and a chamber length 1306 extending along a longitudinal axis 1310 perpendicular to the lateral axis 1180 (FIG. 10). In the example illustrated, the transfer chamber 1148 is at least partially enclosed by an outer chamber wall 1184. In the example illustrated, outer chamber wall 1184 includes opposed first and second end walls 1188, 1192, and opposed first and second sidewalls 1286a, 1286b.

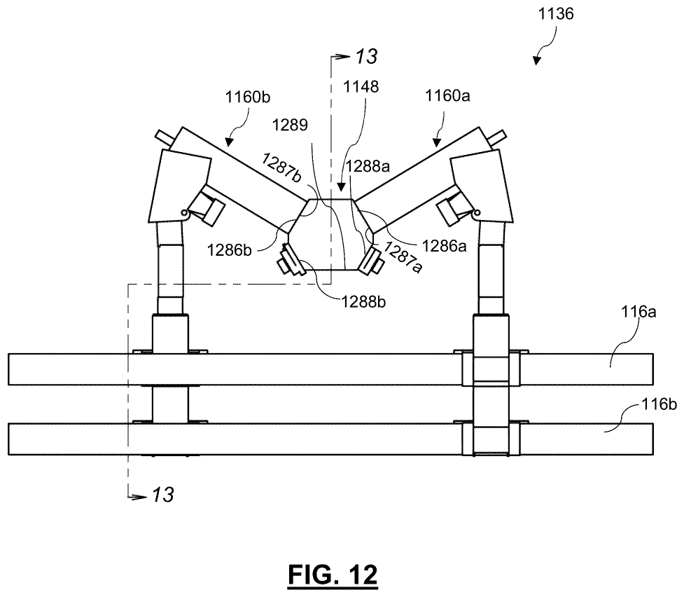

Referring to FIG. 12, in the example illustrated, the first sidewall 1286a includes a first sidewall upper portion 1287a and a first sidewall lower portion 1288a, and the second sidewall 1286b includes a second sidewall upper portion 1287b and a second sidewall lower portion 1288b. The chamber outer wall 1184 further includes a bottom wall 1289 that extends longitudinally between lower ends of the first and second sidewall lower portions 1288a, 1288b. In the example illustrated, the first sidewall upper portion 1287a is generally parallel to the second sidewall lower portion 1288b, and the first sidewall lower portion 1288a is generally parallel to the second sidewall upper portion 1287b, so that in cross-section the walls 1287a, 1287b, 1288a, 1288b, and 1289 form five sides of a hexagonal shape (with an open top opposite the bottom wall 1289).

Referring again to FIG. 10, the chamber width 1176, in the example illustrated, extends from one to the other of the first and second end walls 1188, 1192 and the chamber length 1306 extends from one to the other of the first and second sidewalls 1286a, 1286b.

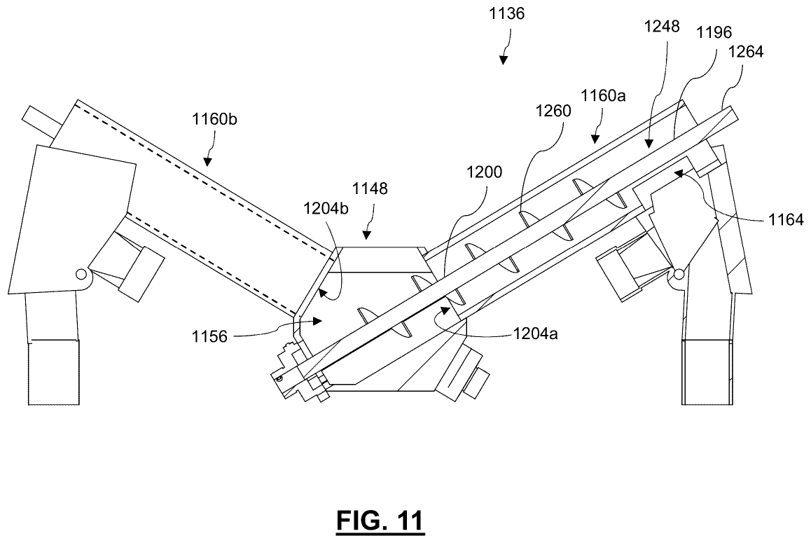

In the example illustrated, at least some of the metering devices 1160 are optionally arranged in pairs. Each pair includes a first metering device 1160a of the plurality of metering devices and a second metering device 1160b of the plurality of metering devices. Referring to FIG. 11, in the example illustrated, the first sidewall 1286a (and more particularly, the first sidewall upper portion 1287a of the first sidewall) includes a plurality of first chamber apertures 1204a and the second sidewall 1286b (and more particularly, the second sidewall upper portion 1287b of the second sidewall) includes a plurality of second chamber apertures 1204b. Each first metering device 1160a is proximate a respective first chamber aperture 1204a and each second metering device 1160b is proximate a respective second chamber aperture 1204b.

In the example illustrated, the quantity of first metering devices 1160a is equal to the quantity of second metering devices 1160b, and all of the metering devices 1160 are arranged in pairs. In some examples, some of the metering devices 160 are arranged in pairs, and one or more others of the metering devices 1160 may not be arranged in pairs, such as, for example, in cases where the quantity of first metering devices 1160a is unequal to the quantity of second metering devices 1160b.

Referring still to FIG. 11, each metering device 1160a, 1160b has a meter outlet 1164 and a rotary propelling member 1196 upstream of the meter outlet 1164 for urging conveyance of metered product from the transfer chamber 1148 to the meter outlet 1164. In the example illustrated, the propelling members 1196 include augers 1248. Each auger 1248 has at least one helical flight 1260 extending along a shaft 1264.

Each rotary propelling member 1196, in the example illustrated, has a protruding portion 1200 that protrudes into the chamber interior 1156 (FIG. 11). In the example illustrated, the protruding portions 1200a, 1200b of the first and second metering devices 1160a, 1160b are interlaced with each other. More particularly, the protruding portions 1200a of the first metering devices 1160a extend from the first sidewall 1286a, past the lateral axis 1180, toward an opposed side of the transfer chamber 1148, and the protruding portions 1200b of the second metering devices 1160b extend from the second sidewall 1286b, past the lateral axis 1180, toward an opposed side of the transfer chamber 1148. The protruding portions 1200a of any two adjacent first metering devices 1160a are spaced apart by a gap occupied by the protruding portion 1200b of a second metering device 1160b. Similarly, the protruding portions 1200b of any two adjacent second metering devices 1160b are spaced apart by a gap occupied by the protruding portion 1200a of a first metering device 1160a. In this way, the protruding portions 1200a, 1200b are interlaced with one another along the chamber width 1176 (lateral axis) of the transfer chamber 1148. Providing the protruding portions 1200 of the metering assembly 1136 in an interlaced arrangement further helps to reduce the size of the transfer chamber 1148, for example, by facilitating a reduction in the space between the opposed first and second sidewalls 1286a, 1286b (i.e., a reduction in the chamber length 1306).

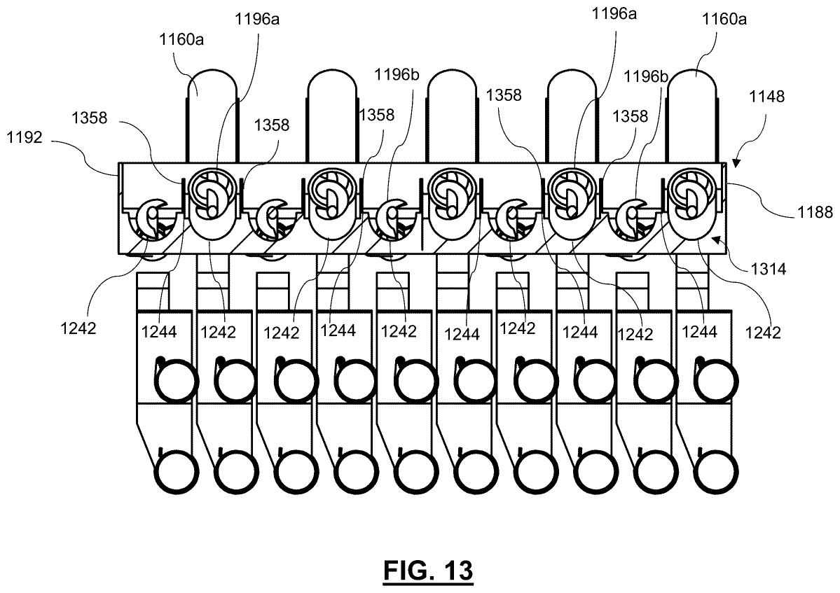

Referring to FIG. 13, in the example illustrated, the transfer chamber 1148 includes an undulating bottom surface 1314 including contoured lower portions (or troughs) 1242 beneath a lower portion of each first and second propelling member 1196a and 1196b and raised portions (or peaks) 1244 between adjacent contoured lower portions 1242 to help reduce product stagnation between adjacent metering devices 1160. Furthermore, in the example illustrated, the transfer chamber 1148 includes optional subdividers 1358 extending upward from upper surfaces of respective peaks 1244, and oriented generally parallel to the end walls 1188, 1192. The subdividers 1358 extend upward from the bottom wall of the transfer chamber 1148 along at least a portion of a height of the transfer chamber 1148 to optionally divide at least a lower portion of the transfer chamber 1148 into a plurality of discrete feed zones, with each feed zone receiving a respective portion of product from the tank 108, to be withdrawn from the transfer chamber 1148 by a respective one of the metering devices 1160.

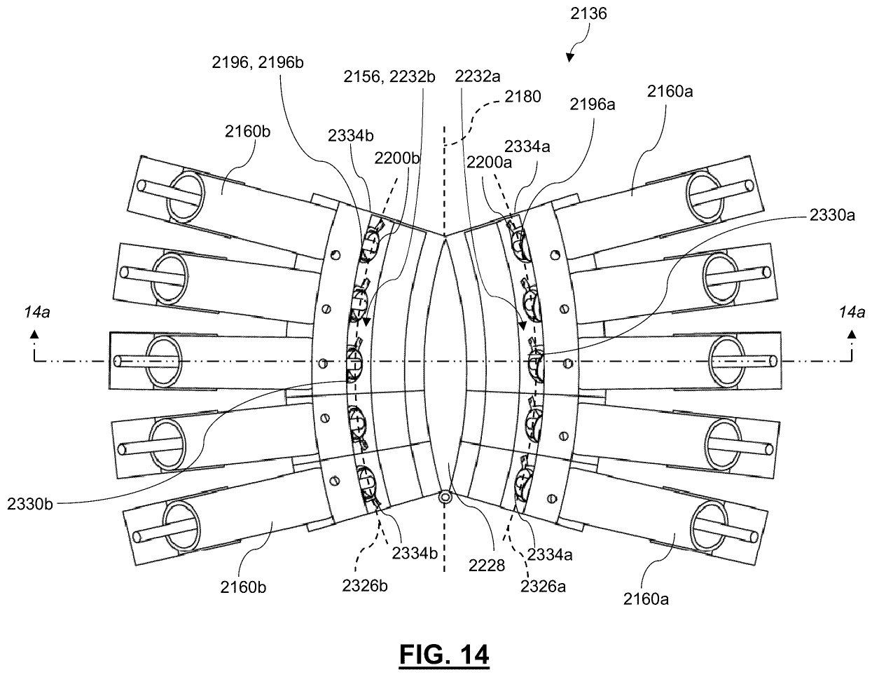

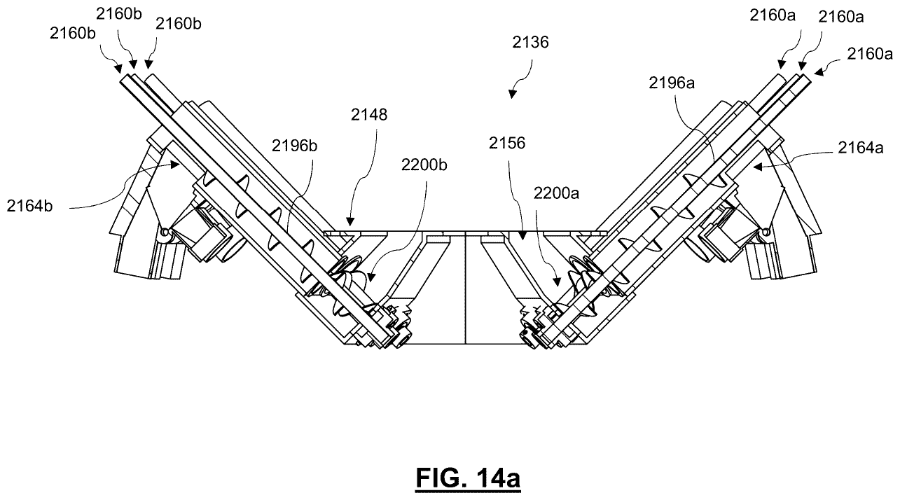

Referring to FIGS. 14 and 14a, another example of a metering assembly 2136 in accordance with aspects of the present teaching has some similarity to the metering assembly 136, with like features identified by like reference characters, incremented by 2000.

The metering assembly 2136 includes a transfer chamber 2148 and a plurality of metering devices 2160 coupled to the transfer chamber 2148. The plurality of metering devices includes multiple first metering devices 2160a arranged side-by-side along a first side of the lateral axis 2180, and multiple second metering devices 2160b arranged side-by-side along a second side of the lateral axis, opposite the first side. In the example illustrated, the metering devices 2160 are optionally arranged in pairs. Each pair includes one of the first metering devices 2160a and a second metering device 2160b of the plurality of metering devices. Each metering device 2160a, 2160b has a meter outlet 2164a, 2164b and a rotary propelling member 2196a, 2196b upstream of the respective meter outlet 2164a, 2164b for urging conveyance of metered product from the transfer chamber 2148 to the meter outlet (FIG. 14a). Each rotary propelling member 2196a, 2196b, in the example illustrated, has a protruding portion 2200a, 2200b that protrudes into the chamber interior 2156.

The transfer chamber 2148, in the example illustrated, includes a lateral divider 2228 that divides the chamber interior 2156 into a first chamber portion 2232a in communication with the first metering devices 2160a and a second chamber portion 2232b in communication with the second metering devices 2160b. In the example illustrated, the lateral divider 2228 comprises opposed convexly curved panels. All of the first metering devices 2160a have access to the product in the first chamber portion 2232a, and all of the second metering devices 2160b have access to the product in the second chamber 2232b. Product entering the first chamber portion 2232a, may ultimately be extracted by any one of the first metering devices 2160a, or at least by either one of two adjacent first metering devices 2160a. Similarly, product entering the second chamber portion 2232b may ultimately be extracted by any one of the second metering devices 2160b, or at least by either one of two adjacent second metering devices 2160b.

In the example illustrated, the protruding portions 2200a of the first metering devices 2160a are spaced apart along a first arc 2326a when viewed from above (FIG. 14). The first arc 2326a has a first arc central portion 2330a disposed between first arc end positions 2334a. The first arc central portion 2330a is spaced further from the lateral axis 2180 than the first arc end portions 2334a. In the example illustrated, the protruding portions 2200b of the second metering devices 2160b are spaced apart along a second arc 2326b when viewed from above. The second arc 2326b is arranged opposite the first arc 2326a and has a second arc central portion 2330b disposed between second arc end positions 2334b. The second arc central portion 2330b is spaced further from the lateral axis 2180 than the second arc end portions 2334b. The arcuately arranged protruding portions 2200a, 2200b of the metering assembly 2136 can allow for a further reduction in the dimensions of the transfer chamber 2148. With the arcuate arrangement of the protruding portions 2200a, 2200b, the chamber apertures 2204a, 2204b can be brought closer together while allowing for sufficient spacing between downstream ends of the metering devices 2160 to accommodate positioning of other components of the metering assembly 2136 (such as, for example, drive motors, bypass conduits, etc.).

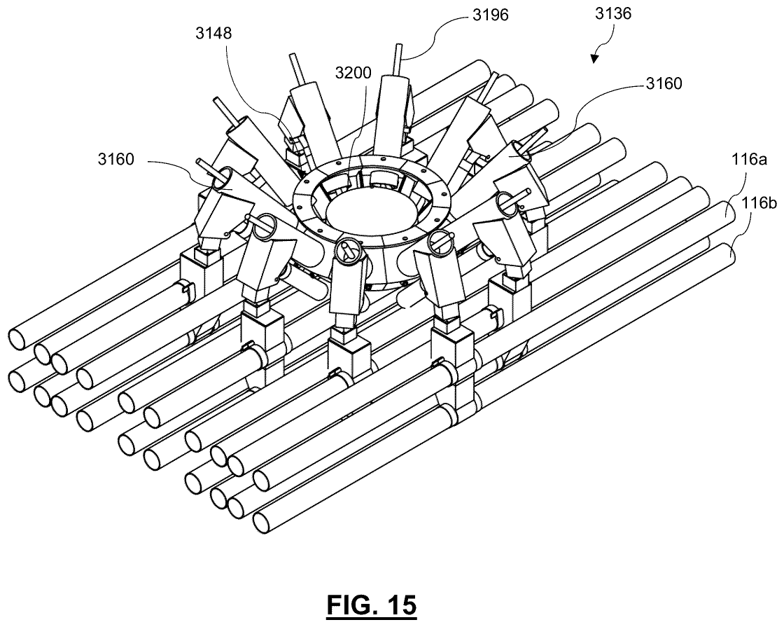

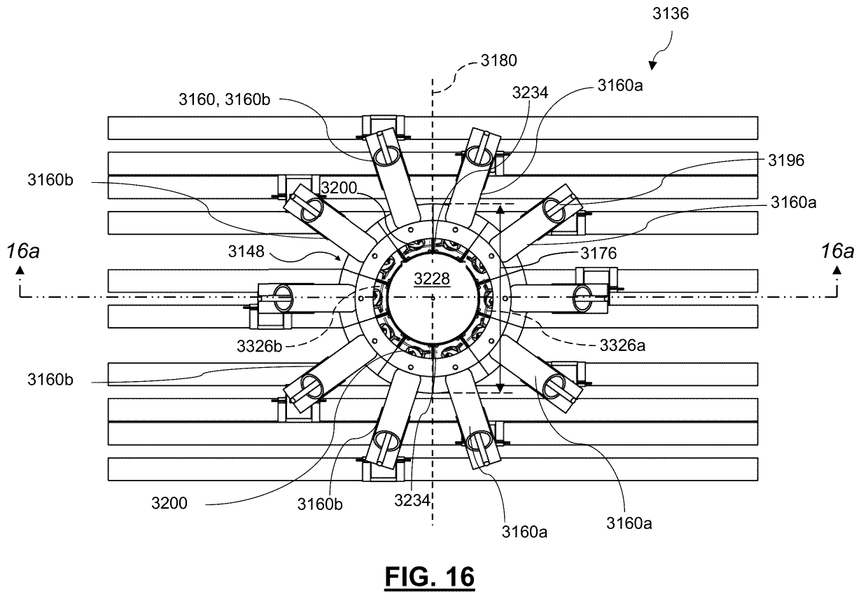

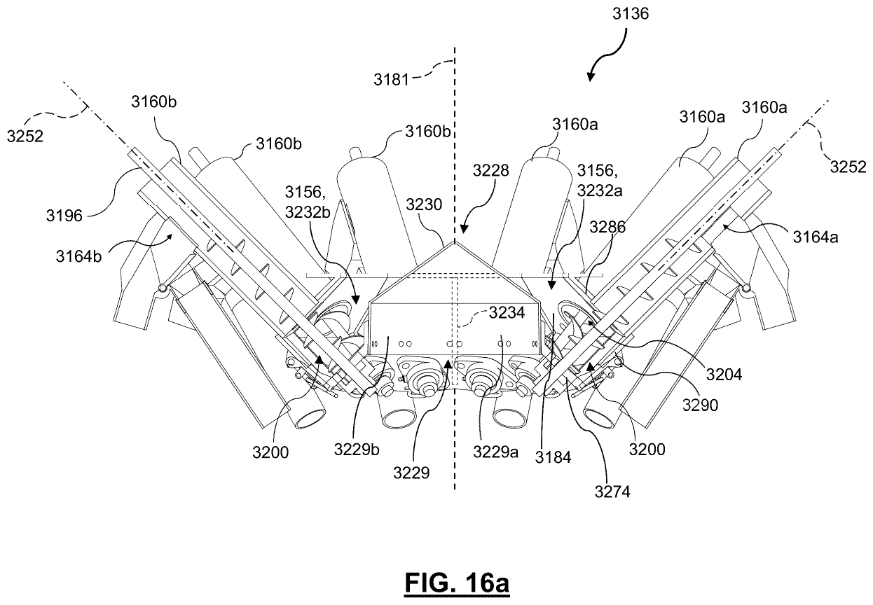

Referring to FIGS. 15, 16 and 16a, another example of a metering assembly 3136 in accordance with aspects of the present teaching has some similarity to the metering assembly 2136, with like features identified by like reference characters, incremented by 1000.

The metering assembly 3136 includes a transfer chamber 3148 and a plurality of metering devices 3160 coupled to the transfer chamber 3148. The plurality of metering devices 3160 includes a plurality of first metering devices 3160a, and a plurality of second metering devices 3160b. In the example illustrated, a set of the first metering devices 3160a are arranged side-by-side along a first arc 3326a on a first (e.g. longitudinally forward) side of a lateral axis 3180 and a set of the second metering devices 3160b are arranged side-by-side along a second arc 3326b on a second (e.g. longitudinally rearward) side of the lateral axis 3180 opposite the first side. In the example illustrated, the first and second arcs 3326a, 3326b are semi-circles, arranged to form a circle when viewed from above, and about which the metering devices 3160 are circumferentially arranged. In the example illustrated, the first and second arcs 3326a, 3326b (and circle formed thereby) extend about a vertical axis 3181 (FIG. 16a) of the transfer chamber 3148 that intersects the lateral axis 3180.

The transfer chamber 3148, in the example illustrated, is at least partially enclosed by a chamber outer wall 3184. In the example illustrated, the chamber outer wall 3184 circumscribes the first and second arcs 3326a, 3326b forming an outer periphery that enclosed the circle formed by the arcs. In some examples, when viewed from above, the chamber outer wall 3184 can be shaped as a circle or a multi-sided polygon or another shape that surrounds the arcs 3326a, 3326b and that has generally equal lateral and longitudinal extents, such shapes collectively referred to herein as a “circumscribing shape”.

In the example illustrated, the chamber outer wall 3184 has a circumscribing shape that is generally circular. The transfer chamber 3148 has a chamber width 3176 (FIG. 16) extending along the lateral axis 3180. In the example illustrated, the chamber width 3176 generally corresponds to an outer diameter of the circularly shaped transfer chamber 3148.

The chamber outer wall 3184 includes a plurality of chamber apertures 3204, each of which is associated with a respective one of the metering devices 3160. In the example illustrated, the chamber outer wall 3184 includes a sidewall 3286 and a bottom panel 3290, and the apertures 3204 are provided in the sidewall 3286. Each metering device extends along a respective meter axis 3252, and at each respective aperture 3204, the sidewall 3286 is oriented generally orthogonal to the meter axis 3252, and the bottom panel 3290 is generally parallel to the meter axis 3252 (FIG. 16a). In the example illustrated, the meter axis 3252 of any one of the plurality of metering devices 3160 is obliquely aligned relative to each meter axis 3252 of the other metering devices 3160. In the example illustrated, the meter axis 3252 of each metering device 3160 is directed radially inward toward the vertical axis 3181.

The transfer chamber 3148, in the example illustrated, includes a lateral divider 3228 that divides the chamber interior 3156 into a first chamber portion 3232a in communication with the first metering devices 3160a and a second chamber portion 3232b in communication with the second metering devices 3160b. In the example illustrated, the lateral divider 3228 comprises a divider central portion that has an outer surface that is spaced radially inward of the chamber outer wall 3184 by a generally uniform radial gap about the periphery of the transfer chamber. The radial gap provides a generally annular interior volume of the transfer chamber extending about a periphery of the transfer chamber.

In the example illustrated, the divider 3228 has a generally circular profile when viewed from above (FIG. 16). The central portion of the divider 3228 includes, in the example illustrated, a cylindrical base portion 3229 (FIG. 16a) concentric with the vertical axis 3181, and a conical cover 3230 having an upper surface that extends upward and radially inward from an upper edge of the base portion. In the example illustrated, the base portion 3229 comprises a first convex wall 3229a directed toward the first chamber portion 3232a and a second convex wall 3229b directed toward the second chamber portion 3232b. In the example illustrated, an inclined panel 3274 extends downward and radially outward from a lower edge of the convex wall. The cylindrical portion 3229, and the convex wall portions 3229a, 3229b need not be perfectly curved surfaces but can be, for example, formed of a series of flat wall segments, which can simplify manufacture of the transfer chamber 3148.

In the example illustrated, the radial gap between the inner surface of the chamber outer wall 3184 and the outer surface of the divider 3228 extends around the periphery of the transfer chamber, presenting an annular or ring-shaped chamber interior for staging product from the tank for pick-up by the metering devices 3160. The divider 3228 further separates the chamber interior into a first chamber portion 3232a on one side of the lateral axis 3180 (and to the right of the vertical axis 3181 in FIG. 16a), and a second chamber portion 3232b on the other side of the lateral axis 3180 (and to the left of the vertical axis 3181 in FIG. 16a). The divider 3228 may optionally include lateral divider walls 3234 extending across the radial gap along the lateral axis (e.g. between the adjacent first and second metering devices 3160a, 3160b on either side of the transfer chamber).

In the example illustrated, all of the first metering devices 3160a have access to the product in the first chamber portion 3232a, and all of the second metering devices 3160b have access to the product in the second chamber 3232b. Product entering the first chamber portion 3232a may ultimately be extracted by any one of the first metering devices 3160a, or at least by either one of two adjacent first metering devices 3160a. Similarly, product entering the second chamber portion 3232b may ultimately be extracted by any one of the second metering devices 3260b, or at least by either one of two adjacent second metering devices 3160b. Having multiple metering devices in communication with product in each chamber portion can help balance or even out the amount of product available for extraction by the metering devices, reducing the chance that any one metering device will be starved of product while other metering devices still have access to product. Furthermore, this balancing of product among multiple metering devices associated with a single chamber portion can help avoid needless and inefficient accumulation of product at a metering device that has been turned off, for example in cases where one or more of the metering devices are temporarily deactivated or otherwise not required for application of the product to the field.

Each metering device 3160 has a meter outlet 3164a, 3164b (FIG. 16a) and a rotary propelling member 3196 upstream of the meter outlet for urging conveyance of metered product from the transfer chamber 3148 to the meter outlet. Each rotary propelling member 3196, in the example illustrated, has a protruding portion 3200 that protrudes into the chamber interior 3156.

Like the metering assembly 2136 of FIG. 14, when viewed from above, the protruding portions 3200 of the first metering devices 3160a are spaced apart along the first arc 3326a and the protruding portions 3200 of the second metering devices 3160b are spaced apart along the second arc 3326b. Referring to FIG. 16, in the example illustrated, each of the first and second arcs 3326a, 3326b are semi-circles. The metering devices 3160 are spaced apart circumferentially when viewed from above. The circular profile of the transfer chamber 3148, in the example illustrated, may help further help reduce the length/width of the lower portion of the tank from which the transfer chamber 3148 receives product, and can help to further concentrate the area of staged agricultural product for withdrawal by the metering devices 3160. This in turn can help reduce starvation of one or more metering devices 3160 and simplify cleanout of the transfer chamber 3148.

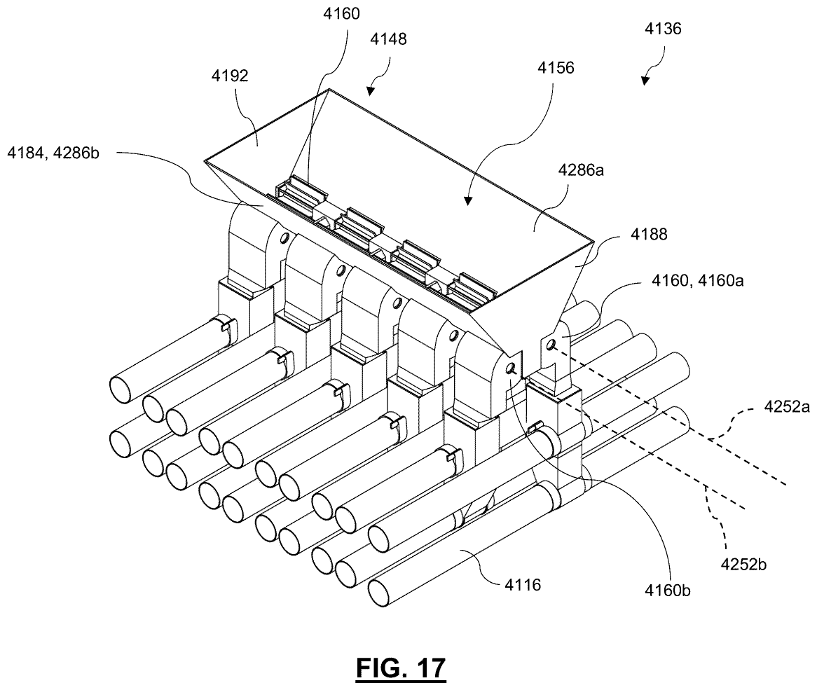

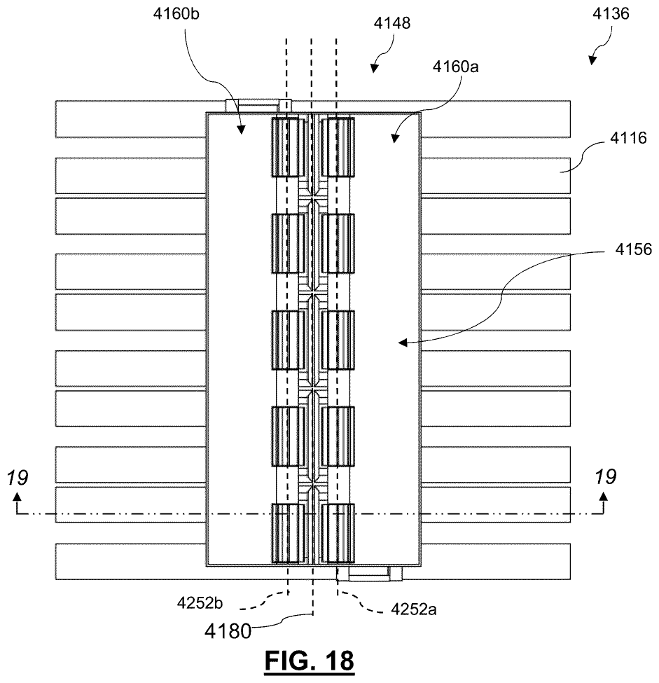

Referring to FIGS. 17-19, another example of a metering assembly 4136 in accordance with aspects of the present teaching has some similarity to the metering assembly 136, with like features identified by like reference characters, incremented by 4000.

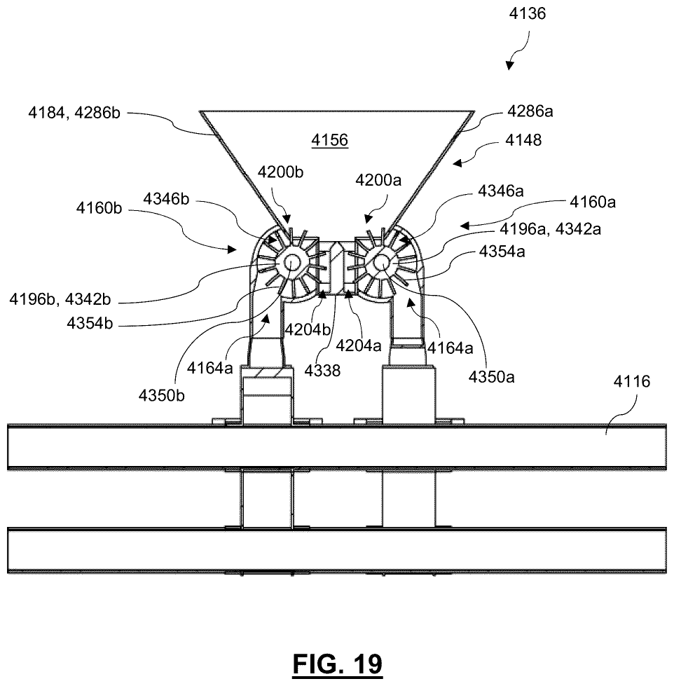

The metering assembly 4136 includes a transfer chamber 4148 that is at least partially enclosed by a chamber outer wall 4184. In the example illustrated, the chamber outer wall 4184 includes first and second sidewalls 4286a, 4286b spaced apart on opposite sides of a lateral axis 4180. The chamber outer wall 4184 further includes a bottom wall 4338 (FIG. 19) extending longitudinally between lower ends of the first and second sidewalls 4286a, 4286b, and laterally between first and second end walls 4188, 4192 of the transfer chamber 4148.

When the metering assembly 4136 is used in conjunction with a distribution system, for example the distribution system 100 (FIG. 1), the transfer chamber 4148 is adjacent a lower end of the tank (e.g., tank 108) of the distribution system. In the example illustrated, the first and second sidewalls 4286a, 4286b and the first and second end walls 4188, 4192 of the transfer channel 4148 are defined by lower portions of sloped sidewalls of the tank. In the example illustrated, the transfer chamber 4148 is disposed within the tank, and is defined by a lower portion of the tank interior.

The transfer chamber 4148 further includes a plurality of first chamber apertures 4204a in the chamber outer wall 4184, the first chamber apertures 4204a spaced laterally apart from one another along the chamber width on a first side of the lateral axis 4180, and a plurality of second chamber apertures 4204b in the chamber outer wall 4184, the second chamber apertures 4204b spaced laterally apart from one another along the chamber width on a second side of the lateral axis 4180 opposite the first side. Referring to FIG. 19, in the example illustrated, each first chamber aperture 4204a extends partially through the first sidewall 4286a and partially through the bottom wall 4338 adjacent the first sidewall 4286a. In the example illustrated, each second chamber aperture 4204b extends partially through the second sidewall 4286b and partially through the bottom wall 4338 adjacent the second sidewall 4286b.

The metering assembly 4136 further includes a plurality of metering devices 4160, including a plurality of first metering devices 4160a and a plurality of second metering devices 4160b. Each first metering device 4160a is coupled to the transfer chamber 4148 proximate a respective first chamber aperture 4204a and has a first meter outlet 4164a and a first propelling member 4196a upstream of the first outlet 4164a for urging conveyance of metered product from the transfer chamber 4148 through the respective first chamber aperture 4204a to the first meter outlet 4164a. Each second metering device 4160b is coupled to the transfer chamber 4148 proximate a respective second chamber aperture 4204b and has a second meter outlet 4164b and a second propelling member 4196b upstream of the second outlet 4164b for urging conveyance of metered product from the transfer chamber 4148 through the respective second chamber aperture 4204b to the second meter outlet 4164b.

In the example illustrated, the metering devices 4160 are arranged along two sides of the transfer chamber 4148, in opposed pairs. Each pair includes a first metering device 4160a of the plurality of metering devices and a second metering device 4160b of the plurality of metering devices. In the example illustrated, the metering assembly 4136 includes five of the first metering devices 4160a and five of the second metering devices 4160b in opposing relation to the first metering devices 4160a.

In the example illustrated, each first propelling member 4196a includes a first rotary body 4342a with a first fluted outer surface 4346a for engaging the product. In the example illustrated, the first rotary body 4342a is in the form of a first metering wheel having a first hub 4350a, and the first fluted outer surface 4346a comprises a plurality of first vanes 4354a extending radially outwardly from the first hub 4350a. First conveyance pockets are formed between circumferentially adjacent first vanes 4354a of the first rotary body 4342a to convey material from the transfer chamber 4148 to respective first meter outlets of each respective first metering device 4160a.

Similarly, each second propelling member 4196b includes a second rotary body 4342b with a second fluted outer surface 4346b for engaging the product. In the example illustrated, the second rotary body 4342b is in the form of a second metering wheel having a second hub 4350b, and the second fluted outer surface 4346b comprises a plurality of second vanes 4354b extending radially outwardly from the second hub 4350b. Second conveyance pockets are formed between circumferentially adjacent second vanes 4354b of the second rotary body 4342b to convey material from the transfer chamber 4148 to respective second meter outlets of each respective second metering device 4160b.

In the example illustrated, the first rotary body 4342a of each first propelling member 4196a includes a first protruding portion 4200a that protrudes into the chamber interior 4156 of the transfer chamber 4148. In the example illustrated, the first protruding portion 4200a comprises a radially outer portion of one or more vanes 4354a aligned with, and protruding though, the respective first chamber aperture 4204a. As the first rotary body 4342a rotates, respective ones of the vanes 4354a will alternately protrude into (and withdraw from) the chamber aperture, and accordingly, will alternately provide the protruding portion 4200a.

Similarly, in the example illustrated, the second rotary body 4342b of each second propelling member 4196b includes a second protruding portion 4200b that protrudes into the chamber interior 4156 of the transfer chamber 4148. In the example illustrated, the second protruding portion 4200b comprises a radially outer portion of one or more vanes 4354b aligned with, and protruding though, the respective second chamber aperture 4204b.

In operation, each metering wheel is urged to rotate about a respective meter axis 4252a, 4252b that is, in the example illustrated, oriented parallel to the lateral axis 4180 of the transfer chamber 4148, and perpendicular to the distribution lines 4116. As each wheel rotates, the vanes 4354 of the protruding portion 4200 engage product in the transfer chamber 4148. Aided by gravitational force acting on the product, the product is received into the conveyance pockets directed upward toward the respective chamber aperture. Upon further rotation, the conveyance pockets sequentially face downward, releasing the product toward the upstream end of a transfer channel for subsequent delivery to a selected distribution line 4116.

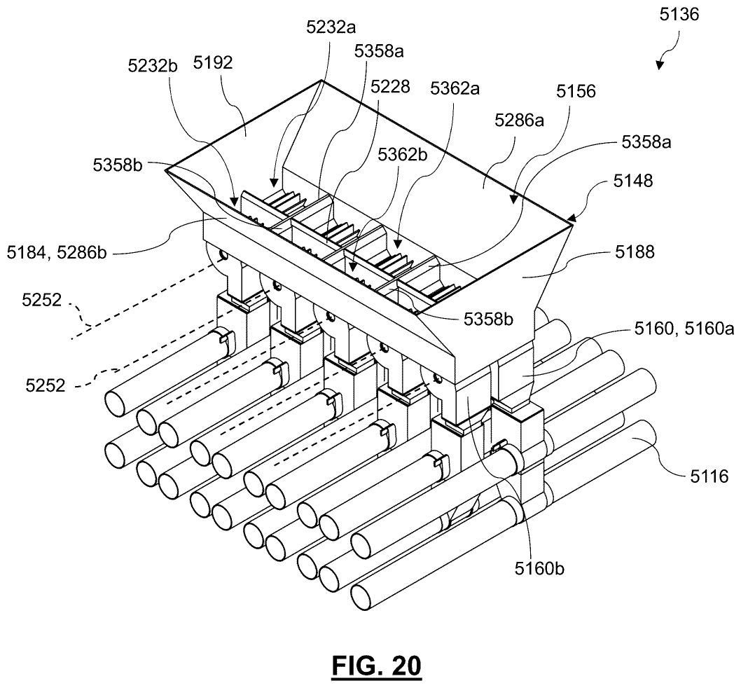

Referring to FIGS. 20-22, another example of a metering assembly 5136 in accordance with aspects of the present teaching has some similarity to the metering assembly 4136, with like features identified by like reference characters, incremented by 1000.

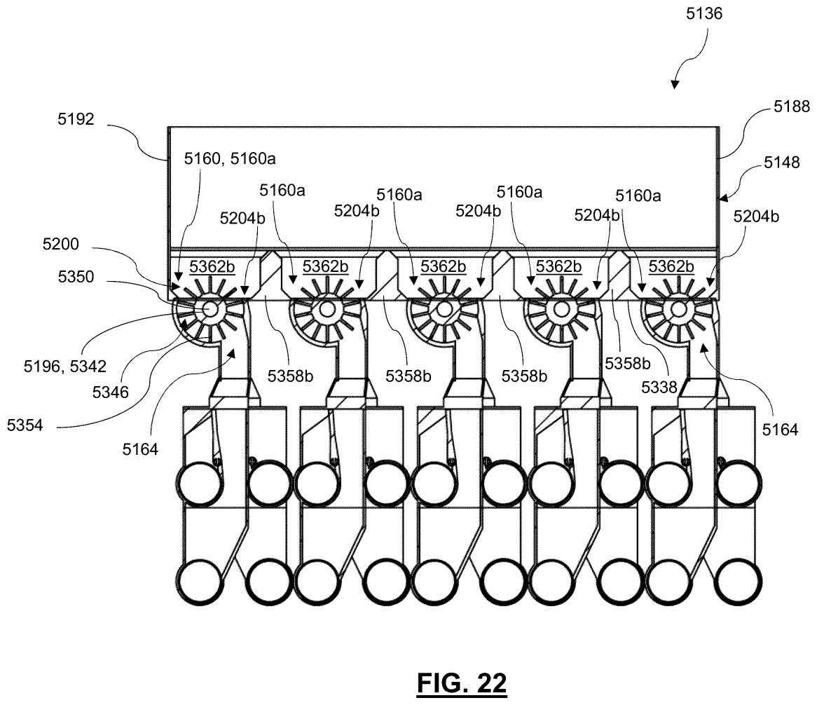

The metering assembly 5136 includes a transfer chamber 5148 that is at least partially enclosed by a chamber outer wall 5184. In the example illustrated, the chamber outer wall 5184 includes first and second end walls 5286a, 5286b spaced apart on opposite sides of a lateral axis 5180. The chamber outer wall 5184 further includes a bottom wall 5338 (FIG. 22) extending longitudinally between lower ends of the first and second sidewalls 5286a, 5286b, and laterally between first and second end walls 5188, 5192 of the transfer chamber 5148.

In the example illustrated, a plurality of first chamber apertures 5204a are formed in the bottom wall 5338 and laterally spaced apart from one another along the chamber width on a first side of the lateral axis 5180. Similarly, a plurality of second chamber apertures 5204b are formed in the bottom wall 5338 and laterally spaced apart from one another along the chamber width on a second side of the lateral axis 5180 opposite the first side. The second chamber apertures 5204b, in the example illustrated, are located at positions along the lateral axis 5180 that are generally equal to the positions along the lateral axis 5180 at which the first chamber apertures 5204a are located.

The metering assembly 5136 further includes a plurality of metering devices 5160, including a plurality of first metering devices 5160a and a plurality of second metering devices 5160b. Each metering device 5160 is coupled to the transfer chamber 5148 proximate a respective one of the first and second chamber aperture 5204a, 5204b and has a meter outlet 5164 and a propelling member 5196 upstream of the meter outlet 5164 for urging conveyance of metered product from the transfer chamber 4148 through the respective chamber aperture 5204a, 5204b to the meter outlet 4164.

In the example illustrated, the metering devices 5160 are arranged along two sides of the transfer chamber 5148, in opposed pairs. Each pair includes a first metering device 5160a of the plurality of metering devices and a second metering device 5160b of the plurality of metering devices. In the example illustrated, the metering assembly 5136 includes five of the first metering devices 5160a and five of the second metering devices 5160b in opposing relation to the first metering devices 5160a.

In the example illustrated, each rotary propelling member 5196 includes a rotary body 5342 with a fluted outer surface 5346 for engaging the product. In the example illustrated, each rotary body 5342 is in the form of a metering wheel having a hub 5350, and the fluted outer surface 5346 comprises a plurality of vanes 5354 extending radially outwardly from the hub 5350. Conveyance pockets are formed between circumferentially adjacent first vanes 5354 of the rotary body 4342 to convey material from the transfer chamber 5148 to respective meter outlets 5164 of each respective metering device 5160.

In the example illustrated, each rotary body 5342 is rotatable about a meter axis extending generally perpendicular to the lateral axis 5180 and generally parallel to the distribution lines 5116. In some examples, rotation of any one of the rotary bodies 5342 is controllable independently of any other one of the first and second rotary bodies 5342.

The transfer chamber 5148, in the example illustrated, includes a lateral divider 5228 that extends between the first and second end walls 5188, 5192. The lateral divider 5228 divides the chamber interior 5156 into a first chamber portion 5232a in communication with the first metering devices 5160a and a second chamber portion 5232b in communication with the second metering devices 5160b. In the example illustrated, the transfer chamber 5148 further includes a plurality of first subdividers 5358a in the first chamber portion 5232a and plurality of second subdividers 5358b in the second chamber portion 5232b.

Referring to FIG. 22, in the example illustrated, each second subdivider 5358b is disposed between a respective pair of adjacent second chamber apertures 5204b and extends upward from the bottom wall 5338 of the transfer chamber 5148 along at least a second portion of the height of the transfer chamber 5148 to provide a plurality of discrete second feed zones 5362b. Each second feed zone 5362b is associated with a respective one of the second metering devices 5160b.

Similarly, in the example illustrated, each first subdivider 5358a is disposed between a respective pair of adjacent first chamber apertures 5204a and extends upward from the bottom wall 5338 of the transfer chamber 5148 along at least a first portion of a height of the transfer chamber 5148 to provide a plurality of discrete first feed zones 5362a. Each first feed zone 5362a is associated with a respective one of the first metering devices 5160a.

Referring still to FIG. 22, the rotary body 5342 of each propelling member 5196 includes a protruding portion 5200 that protrudes into a respective one of the first and second feed zones 5362a, 5362b (FIG. 20). In the example illustrated, each protruding portion 5200 comprises a radially outer portion of one or more vanes 5354 aligned with, and protruding though, the respective chamber aperture 5204a, 5204b. As the rotary body 5342 rotates, respective ones of the vanes 5354 will alternately protrude into (and withdraw from) the chamber aperture, and accordingly, will alternately provide the protruding portion 5200.

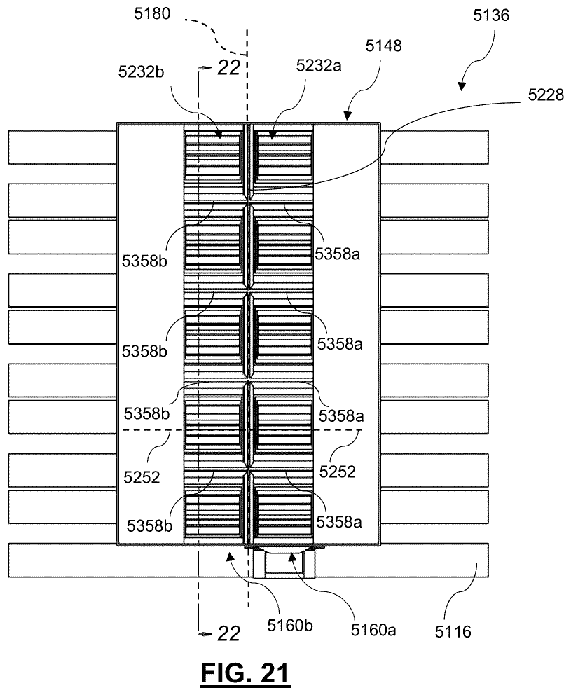

In operation, each metering wheel is urged to rotate about a respective meter axis 5252 that is, in the example illustrated, oriented perpendicular to the lateral axis 5180 of the transfer chamber 5148, and parallel to the distribution lines 5116. Referring to FIG. 21, in the example illustrated, the meter axes 5252 of the first and second metering wheels in each pair of opposed metering devices 5160a, 5160b are colinear.

As each wheel rotates, the vanes 5354 of the protruding portion 5200 engage product staged in a respective one the feed zones 5362a, 5362b in the transfer chamber 5148. Aided by gravitational force acting on the product, the product is received into the conveyance pockets directed upward toward the respective chamber aperture. Upon further rotation, the conveyance pockets sequentially face downward, releasing the product toward the upstream end of a transfer channel for subsequent delivery to a selected distribution line 5116.

What has been described above is intended to be illustrative of examples of the teaching disclosed herein, without limiting the scope of patent claims granted herefrom. The scope of such claims should be given the broadest interpretation consistent with the description as a whole.

1. A distribution system for agricultural product, comprising:
a) a mobile tank for holding a supply of product, the tank including a transfer chamber adjacent a lower end of the tank, the transfer chamber at least partially enclosed by a chamber outer wall and the transfer chamber having a chamber width extending along a lateral axis;
b) a plurality of first chamber apertures in the chamber outer wall, the first chamber apertures spaced laterally apart from one another along the chamber width on a first side of the lateral axis, and a plurality of second chamber apertures in the chamber outer wall, the second chamber apertures spaced laterally apart from one another along the chamber width on a second side of the lateral axis opposite the first side;
c) a plurality of first metering devices, each first metering device proximate a respective first chamber aperture and having a first outlet and a first propelling member upstream of the first outlet for urging conveyance of metered product from the transfer chamber of the tank through the respective first chamber aperture to the first outlet;
d) a plurality of second metering devices, each second metering device proximate a respective second chamber aperture and having a second outlet and a second propelling member upstream of the second outlet for urging conveyance of metered product from the transfer chamber of the tank through the respective second chamber aperture to the second outlet; and
e) a plurality of distribution lines downstream of the first and second outlets for delivery of the metered product from the plurality of first and second metering devices to an agricultural implement for application to a field.

2. The system of claim 1, wherein the second chamber apertures are located at positions along the lateral axis that are generally equal to positions along the lateral axis at which the first chamber apertures are located.

3. The system of claim 1, wherein each first propelling member comprises a first rotary body with a first fluted outer surface for engaging the product, each second propelling member comprises a second rotary body with a second fluted outer surface for engaging the product, wherein rotation of any one of the first and second rotary bodies is controllable independently of any other one of the first and second rotary bodies.

4. The system of claim 1, wherein:
a) each first propelling member comprises a first auger extending along a first meter axis, and a first drive for urging rotation of the first auger;
b) each second propelling member comprises a second auger extending along a second meter axis, and a second drive for urging rotation of the second auger; and
c) rotation of the first and second augers transfers the metered product from the transfer chamber to one or more of the plurality of distribution lines.

5. The system of claim 4, wherein the first auger of each first metering device is rotatable within a first casing disposed external the transfer chamber and extending between the chamber outer wall and the first outlet, and the second auger of each second metering device is rotatable within a second casing disposed external the transfer chamber and extending between the chamber outer wall and the second outlet.

6. The system of claim 4, wherein the lateral axis of the transfer chamber is oriented in a horizontal plane when the mobile tank is on level ground, and wherein each first meter axis is inclined relative to the horizontal plane by a first meter angle and each second meter axis is inclined relative to the horizontal plane by a second meter angle.

7. The system of claim 6, wherein the first outlets of each first metering device are at an elevation greater than the first chamber apertures, and wherein the second outlets of each second metering device are at an elevation greater than the second chamber apertures.

8. The system of claim 4, wherein the transfer chamber is mounted below a discharge opening of the tank.

9. The system of claim 1, comprising three to six of the first metering devices and an equal quantity of the second metering devices in opposing relation to the first metering devices, and wherein the chamber width is less than 100 cm.

10. The system of claim 1, comprising five of the first metering devices and five of the second metering devices in opposing relation to the first metering devices, and wherein the chamber width is less than 85 cm.

11. The system of claim 1, further comprising a lateral divider in the transfer chamber, the lateral divider having a divider width extending generally along the lateral axis and separating the chamber interior into a first chamber portion in communication with the first metering devices and a second chamber portion in communication with the second metering devices.

12. The system of claim 11, wherein each first chamber aperture is in communication with at least one adjacent first chamber aperture through the first chamber portion of the transfer chamber, wherein product entering the first chamber portion proximate any one first metering device is extractable by the one first metering device and by at least another first metering device adjacent thereto.

13. The system of claim 11, wherein each second chamber aperture is in communication with at least one adjacent second chamber aperture through the second chamber portion of the transfer chamber, wherein product entering the second chamber portion proximate any one second metering device is extractable by the one second metering device and by at least another second metering device adjacent thereto.

14. The system of claim 1, wherein the transfer chamber comprises an undulating bottom surface including contoured portions beneath a lower portion of each first and second propelling member and raised portions between adjacent contoured portions to help reduce product stagnation between adjacent metering devices.

15. The system of claim 1, wherein the plurality of distribution lines includes an upper layer of upper distribution lines equal in quantity to a combined total of the plurality of first metering devices and the plurality of second metering devices, the upper distribution lines arranged side-by-side at a common elevation beneath the transfer chamber, wherein a horizontal spacing between sequentially adjacent upper distribution lines alternates between (i) a broad spacing to accommodate a first transfer conduit and a second transfer conduit therebetween, the first and second transfer conduits extending from the first and second outlets, respectively, of a pair of opposed ones of the first and second metering devices for supplying metered product to respective lower distribution lines disposed below the upper distribution lines, and (ii) a narrow spacing to facilitate reducing the chamber width.

16. A method for distributing agricultural product, comprising:
a) staging product in a transfer chamber adjacent a lower end of a mobile tank, the transfer chamber at least partially enclosed by a chamber outer wall and having a chamber width extending along a lateral axis;
b) withdrawing staged product from the transfer chamber through a plurality of metering devices including a set of first metering devices in communication with first chamber apertures in the chamber outer wall arranged side-by side along a first side of the lateral axis and a set of second metering devices in communication with second chamber apertures in the chamber outer wall arranged side-by side along a second side of the lateral axis opposite the first side; and
c) directing metered product from an outlet of each metering device to a respective distribution line for delivery to an agricultural implement for application to a field.

17. A metering assembly for distribution of agricultural product, comprising:
a) a transfer chamber having an open upper end for receiving product into a chamber interior, and a chamber width extending along a lateral axis; and
b) a plurality of metering devices coupled to the transfer chamber, each metering device having a rotary propelling member with a fluted outer surface and a protruding portion that protrudes into the chamber interior and a meter outlet external the transfer chamber, wherein the protruding portions of respective first metering devices of the plurality of metering devices are arranged on a first side of the lateral axis, and the protruding portions of respective second metering devices of the plurality of metering devices are arranged on a second side of the lateral axis opposite the first side.

18. The assembly of claim 17, wherein the protruding portions of the first metering devices are spaced equally from the lateral axis by a first horizontal distance, and the protruding portions of the second metering devices are spaced equally from the lateral axis by a second horizontal distance.

19. The assembly of claim 18, wherein the protruding portions of the first metering devices are spaced apart along a first arc when viewed from above, the first arc having a first arc central portion disposed between first arc end positions, the first arc central portion spaced further from the lateral axis than the first arc end portions.

20. The assembly of claim 19, wherein the protruding portions of the second metering devices are spaced apart along a second arc when viewed from above, the second arc arranged opposite the first arc and having a second arc central portion disposed between second arc end positions, the second arc central portion spaced further from the lateral axis than the second arc end portions.
